(19) United States
(12) Patent Application Publication
(10) Pub. No.: US 2002/0002492 A1
(43) Pub. Date: Jan. 3, 2002

(54) Server apparatus, data processing apparatus, consumable management method, and memory medium and program therefor

(76) Inventor: Shinji Okazawa, Tokyo (JP)

Correspondence Address: FITZPATRICK CELLA HARPER & SCINTO, 30 ROCKEFELLER PLAZA, NEW YORK, NY, 10112, US

(21) Appl. No.: 09/851,560

(22) Filed: May 10, 2001

(30) Foreign Application Priority Data
May 11, 2000 (JP) 138290 / 2000
May 8, 2001 (JP) 137176 / 2001

(51) Int. Cl. G06F 17/60

(52) U.S. Cl. 705/14

(57) ABSTRACT

The invention provides a server for managing, for each user, purchase result, replacement result and frequency of use of a consumable used in an office equipment, and capable, in managing the purchase result of the user, of providing a system of managing the kind and the amount of the consumable in detail and providing a discount service for the purchase of the consumable different for each user according to the managed information, or a system of managing the state of use of the consumable for each user, calculating the demand estimate for the consumable specific to each user according to the managed state of use and providing a discount service to the user according to the calculated demand estimate.

### BACKGROUND OF THE INVENTION

1. Field of the Invention

The present invention relates to a server apparatus and a data processing apparatus for providing a customer with discount service in the purchase of consumables to be used in an office equipment, a toner cartridge management method, and a memory medium and a program therefor.

2. Related Background Art

With the recent progress and spreading of the information processing apparatus such as a personal computer and the network technology such as internet, there are actively executed various businesses utilizing the internet.

For example, there is an increasing trend of recognizing the status of use of the merchandise sold to the customer through the internet connection and utilizing such information for maintenance or for various services, and, in a lease-based contract under which a certain use fee is paid depending on the number of sheets consumed in a copying apparatus, there is known a system in which the payment for consumables such as toner is made according to the count of such number of sheets.

However, in case of the printing apparatus such as printers, the above-described form of payment is sometimes adopted as in the case of the copying apparatus, but, in the majority, the cartridge is purchased one by one after the printer itself is purchased.

In practice, the user in a SOHO environment or the manager in an environment utilizing plural printing apparatus places an order to a personal computer shop or a toner cartridge dealer in consideration of the budget whenever cartridge replacement becomes necessary, and pays a charge determined by a fixed unit price for the toner cartridge and the number of cartridges.

On the other hand, the toner cartridge dealer, even if wishing to provide a service of selling the toner cartridge with different discount rates depending upon the number of the cartridges used by the user, is in fact unable to provide such service as the number of cartridges for each user is not recognized.

Also the user or the manager cannot benefit from such service unless he knows the discount rate in case of a collective purchase through the internet and he understands the number of cartridges to be purchased at a time in consideration of the consumption thereof. Therefore the user or the manager has to execute precise management of the toner cartridges, thus retarding the expansion of such service, so that the levels of satisfaction on both sides cannot still be improved in mutual manner.

### SUMMARY OF THE INVENTION

In consideration of the foregoing, an object of the present invention is to provide a system allowing to manage the status of use of a consumable to be used in a printing apparatus, to calculate the estimate of demand according to such status of use and to provide a discount service linked with such estimate of demand, thereby facilitating the user to execute collective purchase matching the trend of consumption of the consumable and also enabling a collective purchase service including a discount service. The above-mentioned object can be attained, according to the present invention, by a server apparatus capable of managing, through the internet, information of a customer utilizing a data processing apparatus for managing toner cartridge information obtained through communication from a printing apparatus capable of recognizing a mounted state and a replacement state of a toner cartridge to be mounted, the server apparatus comprising management means for managing customer information by obtaining the toner cartridge information managed by the above-mentioned data processing apparatus, estimation means for calculating the estimate of demand for the toner cartridge by analyzing the toner cartridge information in the customer information managed by the management means, preparation means for preparing plural toner cartridge volume discount menus different from customer to customer, and information means for informing the data processing apparatus of the plural toner cartridge volume discount menus prepared by the preparation means.

The aforementioned object can also be attained, according to the present invention, by a data processing apparatus comprising memory means for collecting and storing toner cartridge information based on toner cartridge control information informed from the printing apparatus, transfer means for transferring the toner cartridge information from the memory means to the server apparatus based on a toner cartridge information request from the server apparatus, obtaining means for obtaining toner cartridge volume discount menus informed from the server apparatus, display control means for displaying, in a display unit, the toner cartridge volume discount menus obtained by the obtaining means, designation means for designating one of the toner cartridge volume discount menus displayed for browsing by the display control means, and issuing means for issuing a toner cartridge volume discount purchase order to the server apparatus.

Another object of the present invention is to enable detailed management of the purchase result of each user, more specifically the kind of consumable and the result of purchase for each kind, and to provide a different discount service for each kind thereby enabling a discount service appropriately reflecting the purchase result of the customer. The above-mentioned object can be attained, according to the present invention, by a server comprising identification means for identifying the user and the data processing apparatus based on specification information transmitted through a predetermined communication channel for specifying the user and the data processing apparatus, management means for storing and managing the purchase result of each user in memory means, discount information memory means for storing discount information corresponding to the purchase result for each kind of consumables, and transmission means for transmitting, through the above-mentioned predetermined communication channel, discount information calculated by calculation means for calculating the discount information for the user identified by the identification means and read from the management means by referring to the purchase result of thus identified user stored in the discount information memory means.

Still other objects of the present invention, and the features thereof, will become fully apparent from the following detailed description.

### BRIEF DESCRIPTION OF THE DRAWINGS

FIG. 1 is a view showing the configuration of a printing process system in which a server apparatus, a printing apparatus and a data processing apparatus embodying the present invention are applicable;

FIG. 2 is a block diagram showing the principal configuration of a cartridge order reception management system shown in FIG. 1;

FIG. 3 is a block diagram showing the module configuration of a server apparatus embodying the present invention;

FIG. 4 is a view showing the configuration of a printer engine in a printing system shown in FIG. 1;

FIGS. 5, 6 and 7 are views showing a demand estimate process to be provided to the user in a volume discount service in the server apparatus of the present invention;

FIGS. 8 and 9 are views showing discount rates settable in a toner cartridge discount menu displayed in a manager apparatus in the server apparatus of the present invention;

FIGS. 10, 11, 12, 13, 14, 15, 16, 17 and 18 are views showing examples of the toner cartridge discount menu displayed on the manager apparatus in the server apparatus of the present invention;

FIG. 19 is a block diagram showing an example of a toner cartridge volume discount process by an image processing network system in which the server apparatus and the data processing apparatus of the present invention are applicable;

FIGS. 20A and 20B are flow charts showing examples of a data processing sequence in which the server apparatus and the data processing apparatus of the present invention are applicable;

FIG. 21 is a block diagram showing the configuration of a printing processing system in which a server apparatus, a printing apparatus and a data processing apparatus of a second embodiment of the present invention are applicable;

FIG. 22 is a block diagram showing the configuration of a printing processing system in which a server apparatus, a printing apparatus and a data processing apparatus of a third embodiment of the present invention are applicable;

FIG. 23 is a block diagram showing the configuration of a printing processing system in which a server apparatus, a printing apparatus and a data processing apparatus of a fourth embodiment of the present invention are applicable;

FIG. 24 is a view showing an example of a registration menu for designating date and time for providing the volume discount service in a printing processing system in which a server apparatus, a printing apparatus and a data processing apparatus of a fifth embodiment of the present invention are applicable;

FIG. 25 is a view showing a memory map of a memory medium storing various data processing programs readable by a printing processing system in which the server apparatus, the printing apparatus and the data processing apparatus of the present invention are applicable;

FIG. 26 is a flow chart showing an example of the process on reading, recognition and information of consumable ID information by the printing apparatus of the present invention;

FIG. 27 is a flow chart showing an example of the process for calculating the demand estimate in the server apparatus of the present invention; and

FIG. 28 is a view showing the mode of display of a user interface to be displayed on a display unit of the data processing apparatus of the present invention.

### DESCRIPTION OF THE PREFERRED EMBODIMENTS

First Embodiment

<System Configuration>

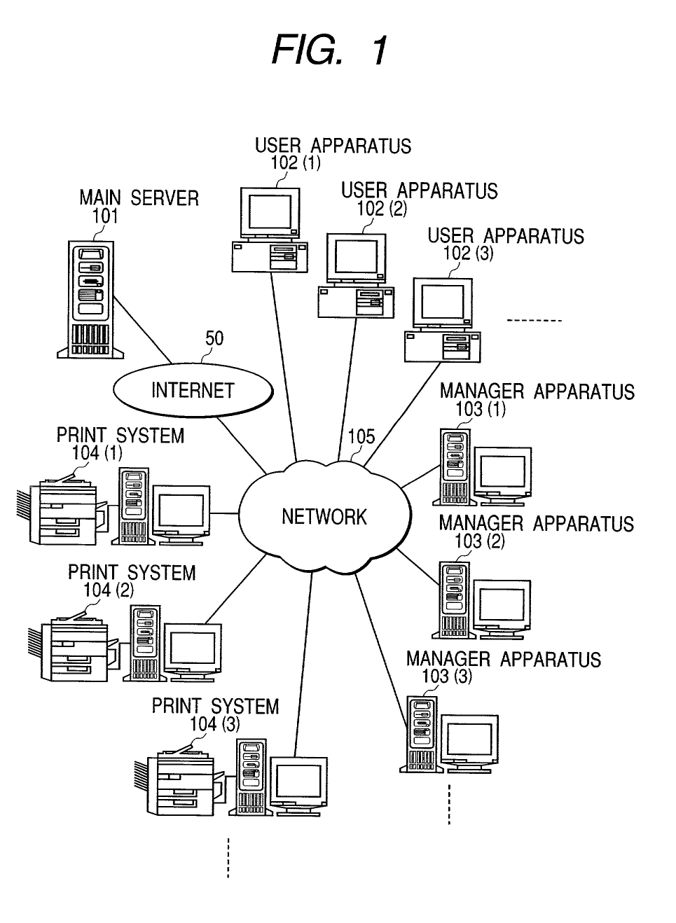

FIG. 1 is a view showing the configuration of a print process system in which a server apparatus, a printing apparatus and a data processing apparatus constituting an embodiment of the present invention are applicable, corresponding for example to a cartridge discount service system utilizing the internet.

In FIG. 1, an information processing apparatus 101 (a computer system composed of a CPU, a ROM, a RAM, an HDD etc.) having the principal processing function in the present embodiment, and will be hereinafter represented as “main server”. The main server 101 is an information processing apparatus generally called server in the internet, and is constantly connected to a network 105 to be explained and has functions for example of returning data in response to a process request from the exterior.

The main server 101 may be composed for example by connecting an external memory system of a large capacity generally called a file server or a database server and plural information processing apparatus, but will be explained as a single information processing apparatus in the following description since there is no difference in function.

Information processing apparatus 102(1), 102(2), 102(3) are to be directly operated by the users of the present embodiment, and will be hereinafter represented as “user apparatus”. In the present embodiment there can be utilized one or plural user apparatus 102(N), and, though plural units are illustrated in FIG. 1, they will be collectively represented as the user apparatus 102 since they are identical in the function.

The user apparatus 102 can be composed of a general personal computer and is provided with a communication apparatus such as a modem for connecting with the network 105 to be explained later for example by an operation of the user, and a data browsing function, generally called the internet browser such as Internet Explorer (trade name) of Microsoft, for transmitting a process request to an internet server desired by the user such as the main server 101 and displaying the data returned from such main server 101. The user of the present system utilizes the user apparatus 102 to achieve document processing, image processing, DPT processing, CAD processing etc. by executing applications, thereby generating final print data.

Information processing apparatus 103(1), 103(2), 103(3) are to be directly operated by the providers (hereinafter represented as “manager”) of the image data to be searched and printed by the user of the present embodiment, and will be hereinafter represented as “manager apparatus”.

In the present embodiment there can be utilized one or plural manager apparatus 103(N), and, though plural units are illustrated in FIG. 1, they will be collectively represented as the user apparatus 102 since they are identical in the function.

The manager apparatus 103 has a connecting function to the network 105 and a data browsing function like the user apparatus 102, and it is assumed that the manager utilizes the manager apparatus 103 to inform the main server 101 of the intention for purchase of the cartridges of printers constituting print systems 104(1), 104(2), 104(3). Naturally the present invention includes a case where the function of the manager apparatus 103 is applied to the user apparatus 102 and the intention for purchase of the cartridges of the printers is informed from a user terminal apparatus to the main server 81.

In the present embodiment, the main server 101 is assumed to be provided for example at the sales agent dealing with the cartridges of different types to be mounted on the printers.

Print systems 104(1), 104(2), 104(3), executing the printing of the image data ordered by the user in the present embodiment, are composed of plural printing apparatus same in type as or different from the information processing apparatus as will be explained later.

In the present embodiment there can be utilized one or plural print systems 104(N), and, though plural units are illustrated in FIG. 1, they will be collectively represented as the user apparatus 104 since they are identical in the function. The print system 104 has a function of receiving print data from the main server 101 for example through a LAN system for making connection to the network 105 and printing such print data by the print apparatus. A network system 105 is composed of the internet in the present embodiment, and, in the following description, the entire system constituting the internet such as communication devices is simply called the network.

In the present embodiment, the network 105 is assumed to be composed of a LAN and the user apparatus 102, the manager apparatus 103 and the print system 104 are assumed to have a connecting function to the LAN, but the present invention can naturally be realized also by employing a network system in which the user apparatus 102, the manager apparatus 103 and the print system 104 can be directly connected to the main server 101 by dialing.

<Block Diagram of Information Processing Apparatus>

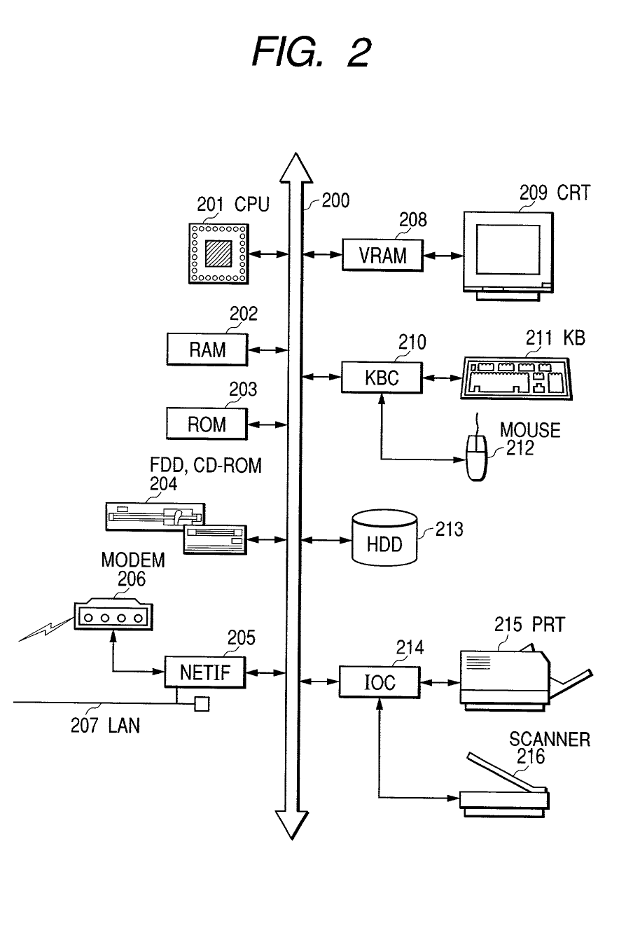

FIG. 2 is a block diagram showing the principal configuration of the cartridge order reception management system shown in FIG. 1, corresponding to the configuration of the information processing apparatus consisting of 101 to 104.

Referring to FIG. 2, a system bus group 200, hereinafter simply called a system bus, constitutes a transmission channel for connecting various units to be explained later in the casing of the information processing apparatus and for transmitting data and control information among such units.

A central processing unit 201 for executing various controls and calculations in the information processing apparatus will be hereinafter represented as CPU. A random access memory 202, hereinafter represented as RAM, serves as an area for an application to be executed and an execution area and a data area for such program.

A read-only memory 203, storing the operation sequence of the CPU 201 and represented hereinafter as ROM, serves to store a basic program (generally called BIOS) for controlling various units in the information processing apparatus and information required for operating the system. A unit group 204, for data input and output for a detachable external memory medium such as a floppy disk or a CD-ROM, will be hereinafter collectively called an FDD.

A network interface 205, for connection to an external network or a LAN 207 to be explained later through a modem 206 to be explained later, will be hereinafter collectively called NETIF. The NETIF 205 executes control for data transfer among the information processing apparatus through the network and diagnosis of the connection state.

A device 206, for connecting the external network and the information processing apparatus through a telephone line, can be generally composed of a modem or a terminal adaptor (TA) for ISDN connection and will be hereinafter collectively called a modem.

A network system 207 such as an ethernet will be hereinafter collectively called a LAN. For example, the connection of the main server 101 to an external apparatus such as a file server is made principally through the LAN 207.

In FIG. 1, each information processing apparatus is connected to the network 105 either through the modem 206 or through a communication device such as a router or a gateway connected on the LAN 207.

A video RAM (VRAM) 208 executes development of image data to be displayed on a CRT 209 to be explained later, thereby executing display control. A display device 209 such as a cathode ray tube will hereinafter be called a CRT.

A controller 210 for controlling input signals from external input apparatus 211, 212 to be explained later will be hereinafter represented as a KBC. A keyboard 211 to be used for an input operation by the user of the information processing apparatus will be hereinafter represented as a KB.

A pointing device 212 to be used for an input operation by the user of the information processing apparatus will be hereinafter represented as a mouse.

The main server 101 shown in FIG. 1 does not necessitate the CRT 209, KB 211 and mouse 212 and is preferably used exclusively for managing the information processing apparatus.

A hard disk drive 213, represented hereinafter as an HDD, is used for storing an application program and various data. In the present embodiment, the application program means a software program for operating various process means constituting the present embodiment.

There are also shown a controller 214 (hereinafter represented as IOC) for controlling an external input/output apparatus to be explained later, a printer 215 ((hereinafter represented as PRT), and a scanner 216. It is also possible to connect other input/output apparatus than the PRT 215 or the scanner 216, such as an externally connected HDD or an MO drive, through the IOC 214, but such apparatus will be omitted from the description as they are not indispensable in the present embodiment.

In each information processing apparatus, the IOC 214, the PRT 215 and the scanner 216 may be dispensed with.

In the print system 104 shown in FIG. 1, the printing apparatus is connected through the NETIF 205 or the IOC 214.

<Module Configuration>

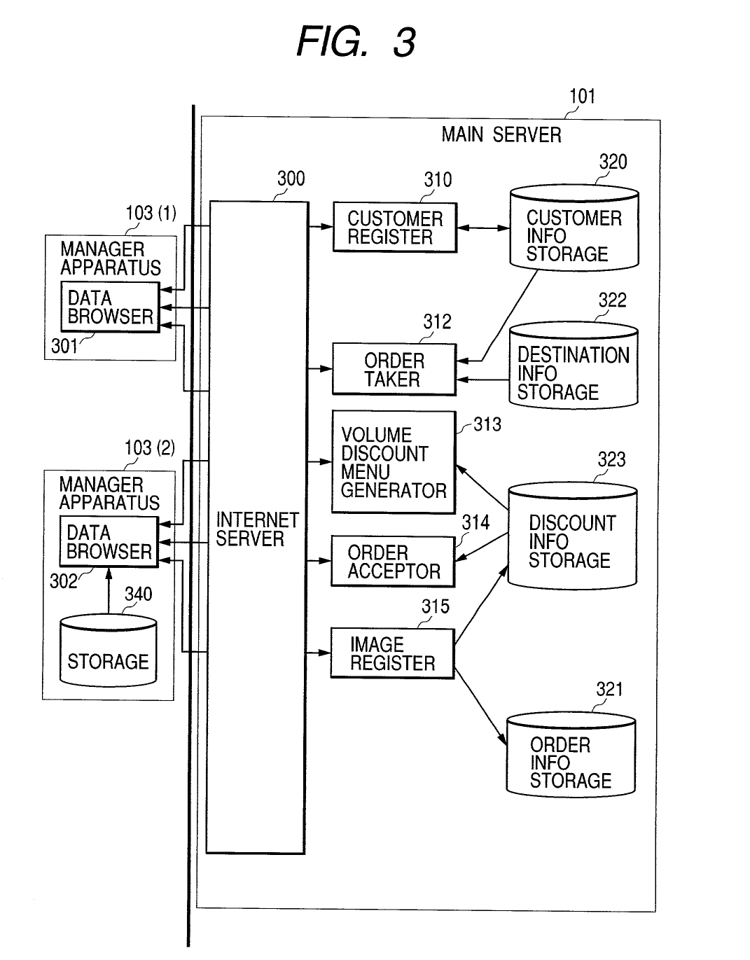

FIG. 3 is a block diagram showing the module configuration of the server apparatus of the present invention, corresponding to a configuration including a group of process means functioning in each of the information processing apparatus namely the main server 101, the user apparatus 102, the manager apparatus 103 and the print system 104, and a group of data storage apparatus and also showing the outline of the principal data flow among such data storage apparatus.

In FIG. 3, numerals 300, 301, 302, 313 and 316 indicate applications programs functioning as process means and read from the HDD213, FDD 204 or RROM 203 in each information processing apparatus and developed in the RAM 202 for use as will be explained later in more details, or modules functioning as a part of such programs.

Numerals 320, 322, 323 indicate data storage apparatus which, as will be explained later in more details, execute data storage in at least one of the HDD 213, the FDD 204 and the RAM 203 in each information processing apparatus, utilizing a file system or a commercially available database system.

In FIG. 3, arrows indicate principal ones of the data flows among the process means and between the process means and the storage apparatus. The data flow over the main server 101, the user apparatus 102, the manager apparatus 103 and the print system 104 is transmitted through the NETIF 205 of each information processing apparatus and the network 105.

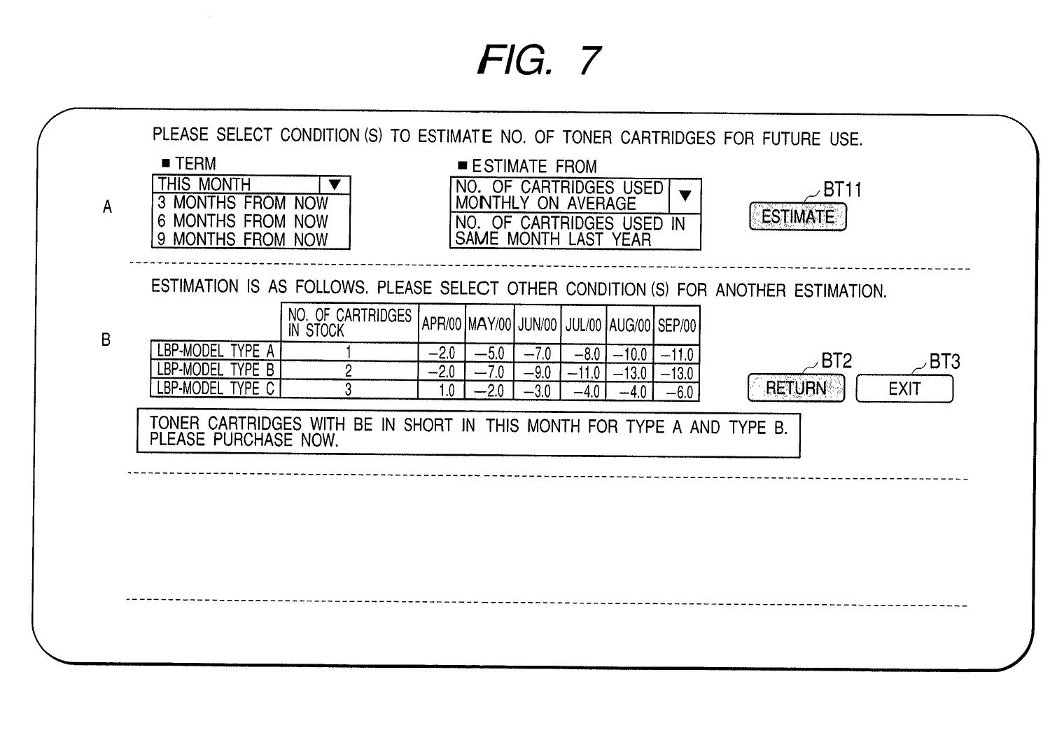

Referring to FIG. 3, a server program group 300 on the internet will be hereinafter collectively represented as an internet server. The internet server 300 constantly runs on the RAM 202, and has a function of executing an appropriate process on a process request received from the exterior through the NETIF 205 and returning data, for example including a function generally called the web server for receiving an HTTP (hyper text transfer protocol) and returning the content of a requested data file or for activating designated process means and returning the output of such process means, and a function generally called the FTP server for receiving an FTP (file transfer protocol) and returning or receiving a requested data file. Display information for executing displays to be explained later in relation to FIGS. 7 to 18, 23, 24 and 28 will be transmitted by the internet server 300 from the main server 101 to the manager apparatus 103.

Data browsing programs 301, 302, generally called an internet browser such as the Internet Explorer (trade name) of Microsoft, U.S., will be hereinafter represented as a data browser. The data browsers 301, 302 are application programs which can be activated upon being read into the RAM 202 in response to an instruction of the user of the information processing means, and have a function of making connection with the network 105 through the NETIF 205 of the information processing apparatus and transmitting, in response to an input from the user, data requesting a process according to such input to the network 105, and a function of displaying data returned from the main server 101 through the network 105 on the CRT 209 of the information processing apparatus.

Other process means (process programs) 310 to 314 functioning on the main server 101 shown in FIG. 3 are developed on the RAM 202 by the internet server 300 in response to a process request from the exterior.

In the main server 310, customer registration means 310 has a function of receiving user information such as name and address of a user, entered by the user by operating the user apparatus 102 or the manager information 103 shown in FIG. 1 and a type number of the printing apparatus, and storing such user information in a customer information storage apparatus 320 to be explained later.

Order taking means 312 has a function of receiving cartridge order data entered by the user by operating the user apparatus 102 or the manager apparatus 103 and, after various checks, storing such cartridge order data in an order information storage apparatus 321 to be explained later.

Volume discount menu generation means 313 has a function of searching and calculating volume discount information for each user from the discount information storage 323 based on an instruction of the manager by operating the manager apparatus 103 and returning the content of thus generated volume discount menu to the manager apparatus 103 through the internet server 300. Display information for executing displays to be explained later in relation to FIGS. 7 to 18, 23, and 24 will be generated by the discount menu generation means 313.

Order accepting means 314 has a function of receiving, in response to the volume discount menu provided by the manager by the volume discount menu generation means, an instruction input for accepting or denying the order data and renewing the content of the order data in the order information storage apparatus 321 according to the content of such input.

Customer information storage apparatus 320 has a function of storing, for each user, user data to be explained in the following on the users of the present system. The customer information storage apparatus 320 also has a function of uniquely searching, by the user ID as the key, the user data (user identifier (user ID), user authenticating identifier (user password), name or corporate name, mail zip code, address, telephone number, e-mail address, name of person in charge (in case of corporate), list of authenticated manager IS's and used printer ID).

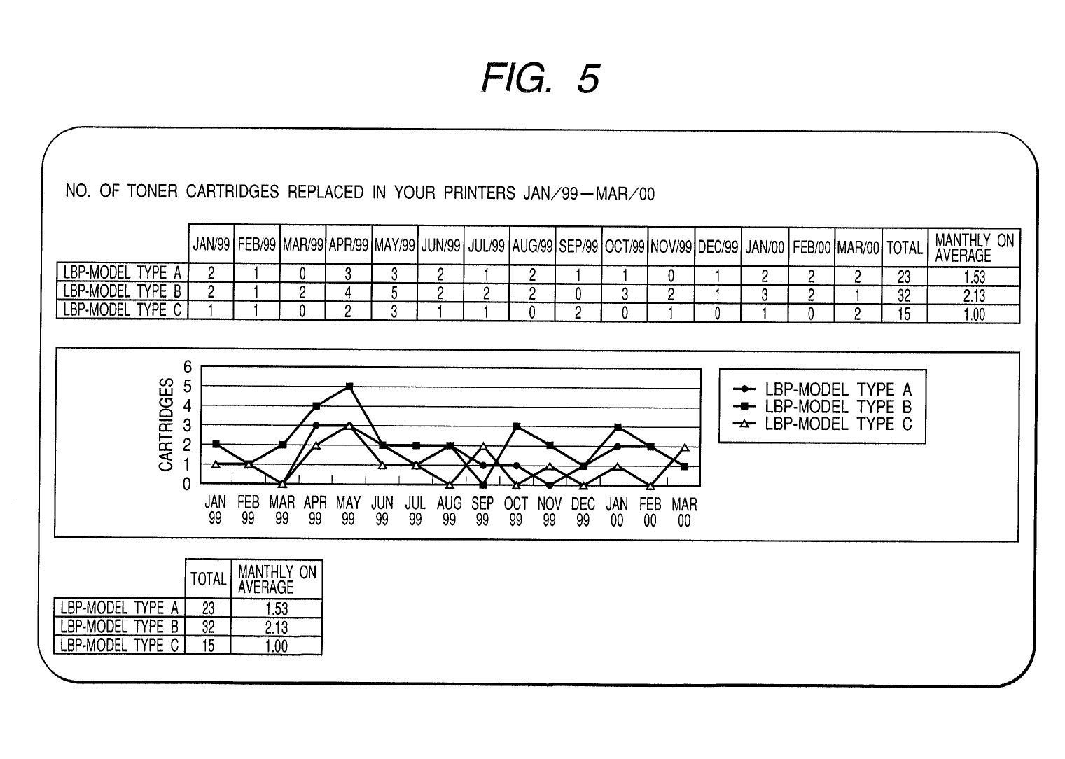

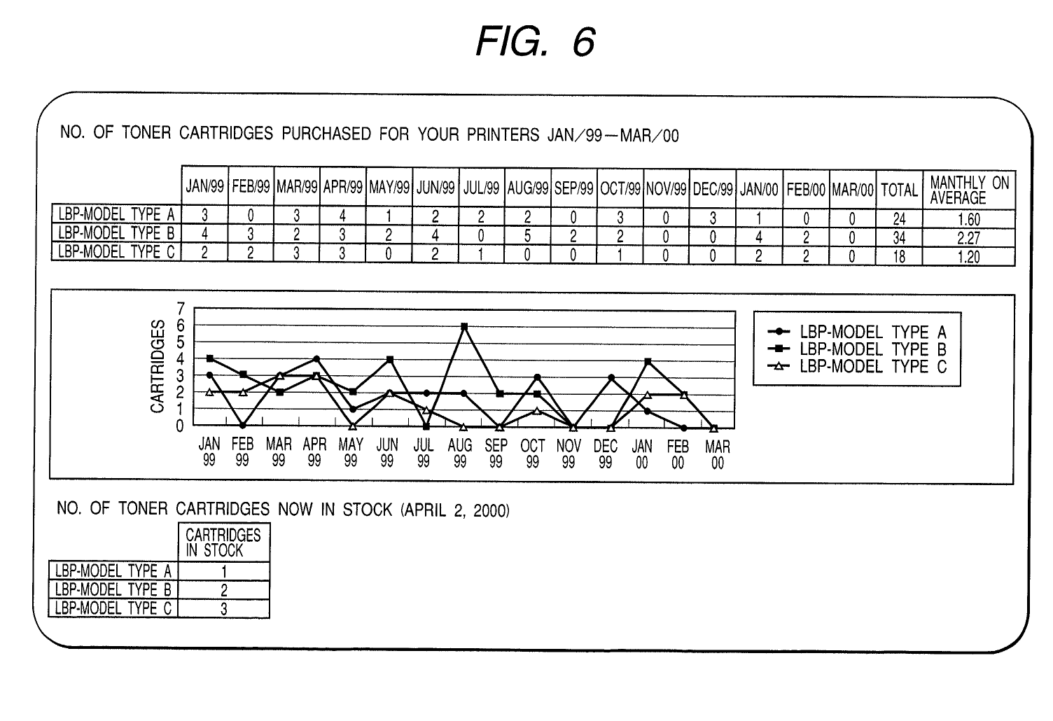

It also has a function of managing purchase date of each consumable for each customer, kind of purchased consumable, purchase history at least including quantity, replacement history for each kind of consumables, recovery (collection) history for each kind of consumables, history of use of service information etc. FIGS. 5 and 6 show examples of the history information managed by the customer information storage apparatus 320.

The customer information storage apparatus also has a function of receiving order data from the aforementioned order taking means 312 and renewing the managed content according to the data received by the order receiving means 314.

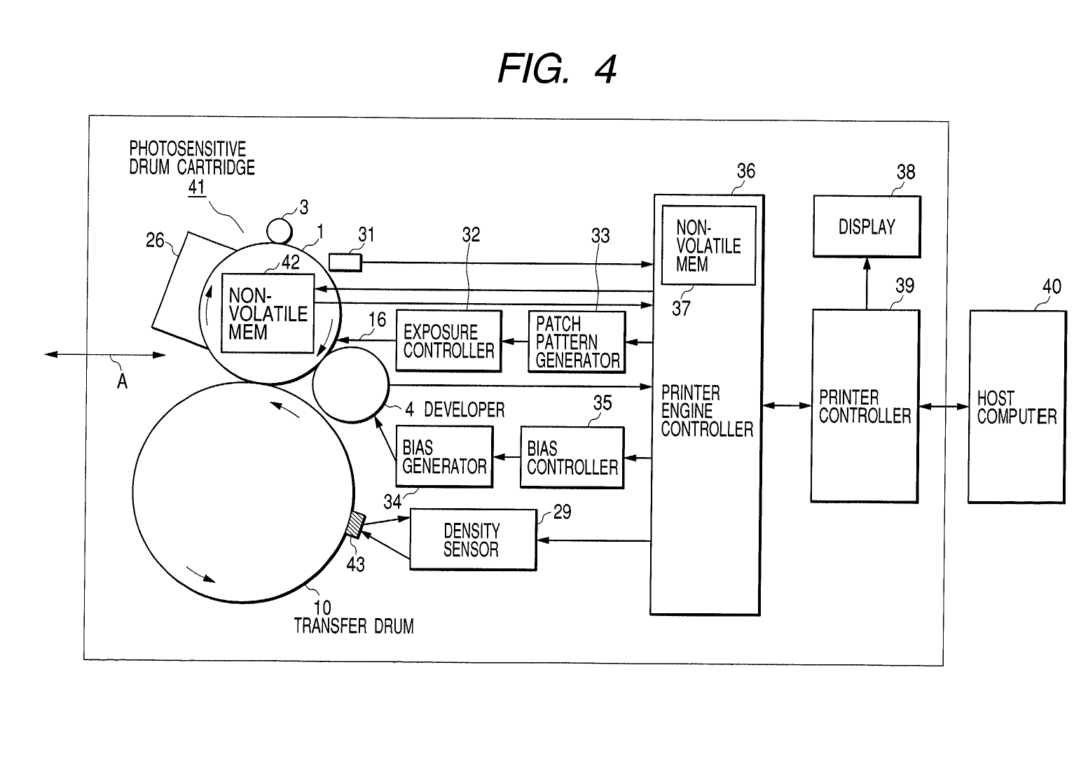

FIG. 4 shows the configuration of the printer engine of the print system 104 shown in FIG. 1.

Referring to FIG. 4, a printer engine control circuit 36 executes sequence control of a printer engine for achieving a printing operation by an electrophotographic process, based on an image signal outputted from a host computer 40 and a printer controller 39. The printer engine control circuit 36 is also provided with a non-volatile memory 37 for storing an identification number (ID) of a photosensitive drum cartridge 41, and such ID can be collected, whenever required, by the manager apparatus 103 of the network of the print system and can be informed to the main server 101. In the present embodiment, the informing means a process of transmitting predetermined information for achieving precise informing, but is explained by a word “informing” for the purpose of clarity.

A photosensitive drum cartridge 41 is integrally provided with a photosensitive drum 1, a charging roller 3, a cleaning box 26 for containing used toner, and a non-volatile memory 42 storing the ID of the photosensitive drum cartridge 41 (ID being information unique to this unit and different from those of other cartridges, such as a serial number), number of used sheets, sensitivity information etc., and is rendered detachably from the main body of the apparatus as indicated by an arrow A.

A photosensitive drum cartridge mounting sensor (sensor) 31 detects whether the photosensitive drum cartridge 41 is mounted.

A developer unit 4 contains toner for visualizing a latent image formed on the photosensitive drum 1 in response to a laser beam corresponding to the image data. The developer 4 is provided with an unrepresented sensor for detecting a toner low level, thereby being capable of informing the printer engine control circuit 36 of a replacement request for a toner cartridge.

A transfer drum 10 is used, in a printing operation, for winding a transfer sheet thereon for transferring image thereon. In an image density control sequence, for stabilizing the image density, the printer engine control circuit 36 sends a command to a patch pattern generating circuit 33 to generate certain predetermined patches, thereby causing an exposure control circuit 32 to emit the laser light and forming a latent image on the photosensitive drum 1.

The printer engine control circuit 36 also activates a developing bias control circuit 35 to apply different biases to the patches generated by a developing bias generating circuit 34, and such patches are rendered visible. The patch image 43 is directly transferred onto the transfer drum 10, and the optimum developing bias is determined by measuring the density of the patches with a density sensor 29.

A printer controller 39 is rendered capable of developing image data into bit map data based on the data transmitted from a host computer 40 connected through a predetermined communication channel (including network) and exchanging command and status with the printer engine control circuit 36 for informing the host computer 40 of the low toner information in the photosensitive drum cartridge 41, thereby clearly indicating the replacement request to the user (manager). A display circuit 38 controls an unrepresented display unit.

The printer controller 39 is rendered capable of detecting the low toner information informed from the photosensitive drum cartridge 41, and also detecting the mounting of a new photosensitive drum cartridge 41 in a full toner state through the comparison of the ID information thereof with the information on the nonvolatile memory 37.

Consequently, even if the same photosensitive drum cartridge 41 is mounted again, it is not recognized as the mounting of a new cartridge 41. Also the host computer receiving such ID information manages the plural cartridges ID's, and the overlapping in the cartridge ID management can be avoided by judging, in case an already managed ID is informed, that a cartridge with an ID already informed to the host computer is mounted on another print apparatus. Though not illustrated in FIG. 4, the printer controller 39 or the printer engine 37 is rendered capable of detecting various error states such as absence of sheet or a failure of a sheet conveying motor, detected by sensors provided in the printer and transmitting thus detected information from the printer controller 39 to an external apparatus such as the host computer through a predetermined communication channel.

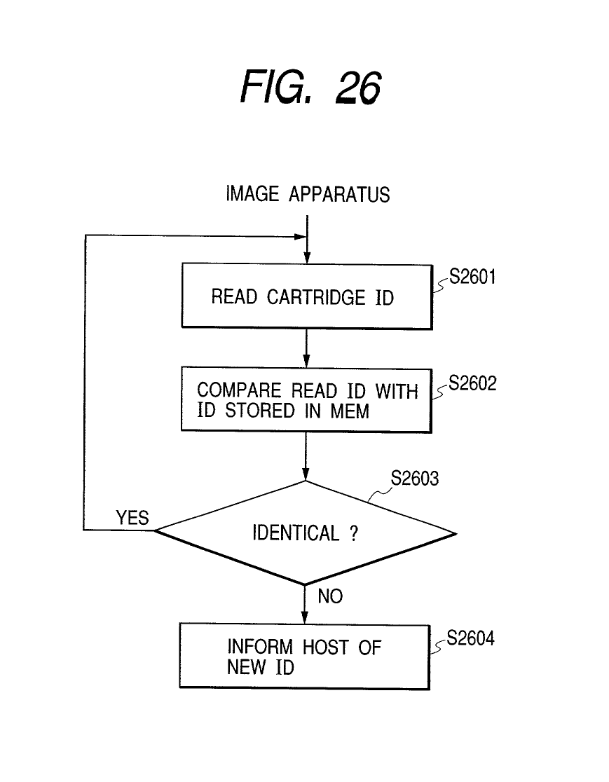

Now reference is made to FIG. 26 for explaining a process of reading and informing the ID stored in the memory means provided in the cartridge. Such process is realized by a CPU provided in the printer, by executing a program stored in a non-volatile memory means such as a ROM.

In a step S2601, the cartridge ID is read from the photosensitive drum cartridge 41 provided in the main body of the apparatus. Then steps S2602, S2603 discriminate whether the read ID is same as the ID stored in the non-volatile memory in the main body.

If same, the informing process is not executed, but, if not same, namely if a cartridge of a new ID is mounted, a step S2604 informs an external apparatus capable of communication through a predetermined communication channel (for example host computer) with such ID information.

On the other hand, when the aforementioned low toner information is informed from the printer controller 39 to the host computer 40, the host computer 40 collects the low toner information and the information on the already replaced cartridge. The host computer 40 corresponds to the manager apparatus 103 or the user apparatus 102 shown in FIG. 1.

Then, based on the order result in the past and the result of use of the photosensitive drum cartridge 41, there is obtained the current inventory status of the cartridge or calculated the monthly result of use of the photosensitive drum cartridge 41, thereby estimating the optimum timing and quantity of ordering the photosensitive drum cartridges 41 as will be explained later in more details.

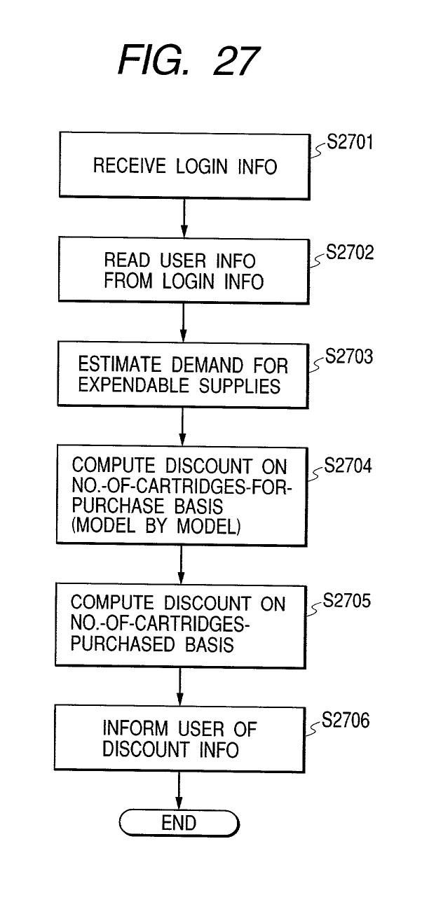

Now there will be outlined, with reference to FIG. 27, the processes in the data processing apparatus and the server apparatus in the present invention.

FIGS. 5 to 7 are views showing the demand estimating process which is proposed to th user at a volume discount service in the server apparatus (main server 101) of the present invention, generated therein and transmitted to the manager apparatus 103 of the user side, and showing examples of display on the display unit of such manager apparatus. The display is for example made in the unit of a page. FIG. 5 corresponds to the result of estimate obtained from the number of replacements of the toner cartridge, and FIG. 6 corresponds to the result of estimate obtained from the cumulative number of purchase of the toner cartridges.

In the main server 101 shown in FIG. 1, upon receiving, from the manager information 103 through the internet 50, the information including at least the low toner information and the past toner replacement information informed from the printer controller 39 together with the user ID, there is recognized the number of replacement of the toner cartridges (photosensitive drum cartridges 41) for each model and each month, in the print systems 104(1) to 104(3) installed at the user. There is recognized the purchased number of the toner cartridges for each printer model at the user, and the number of toner cartridges held by the user is recognized from the aforementioned number of replacements of the toner cartridge and the number of the purchased toner cartridges. The term “recognize” means to store and manage the relevant data.

In such operation, the number of the toner cartridges to be purchased on the basis of the monthly averaged number of the toner cartridge replacements can be calculated by subtracting the monthly averaged number of the toner cartridge replacements from the number of toner cartridges held by the user for example at a month N. Therefore, the number of the toner cartridges to be purchased at a month (N+2) can be obtained by subtracting the monthly averaged number of the toner cartridges replacements multiplied by 2, from the number of the toner cartridges held by the user. Such estimating method corresponds to the “estimation from” in a section A in FIG. 7, and to a case where “from monthly averaged number of used cartridges” is instructed by the user interface.

On the other hand, the number of the toner cartridges to be purchased on the basis of the result of the toner cartridge replacements in the same month previous year can be obtained by subtracting the number of the toner cartridge replacements in the same month previous year from the number of the toner cartridges held by the user at the month N.

For example, the number of the toner cartridges to be purchased until a month (N+2) can be calculated by subtracting the number of the toner cartridge replacements in a month (N+1) previous year from the number of the toner cartridges held by the user at the month N, and further subtracting the number of the toner cartridge replacements in a month (N+2) previous year. Such estimating method corresponds to the “estimation from” in a section A in FIG. 7, and to a case where “from number of used cartridges in the same month previous year” is instructed by the user interface. The result of use in the present invention will be explained later with reference to FIG. 5. In the present invention, the server apparatus can manage the number of toner cartridge replacements for each kind, and can calculate the demand estimate according to the number of toner cartridge replacements for each kind.

The demand estimation is executed in this manner, based on the user information collected from the manager apparatus 103 to the main server 101, and the result of estimation is informed to the manager apparatus 103.

In response, the display unit of the manager apparatus 103 displays two different estimate images shown in FIGS. 5 and 6 by a browser.

In response to the depression of a button not shown in FIGS. 5 and 6, there is displayed an image for setting the number estimating condition, as shown in FIG. 7.

FIG. 7 shows an example of the image for setting the cartridge number estimating condition, to be displayed on the display unit of the manager apparatus 103 shown in FIG. 1, wherein a section A constitutes an image for setting the estimating condition while a section B indicates the result of such estimation. The various information, entered in the manager apparatus through the condition setting image A by a pointing device such as a mouse of a keyboard,is supplied to the main server 101, which in response executes an operation program stored in advance in the memory means to obtain a result of calculation, and transmits the calculated result to the manager apparatus 103 of the user side for display on the display unit thereof (section B in FIG. 7).

In the section A in FIG. 7, an input field corresponding to “term” is used for setting the period of demand estimation, and an input field corresponding to “estimation from” is used for selecting the method for estimating the demand. For example, if “from average number in the past” is selected by the user as the estimating method, the server apparatus calculates the demand estimate based on the data shown in FIG. 5.

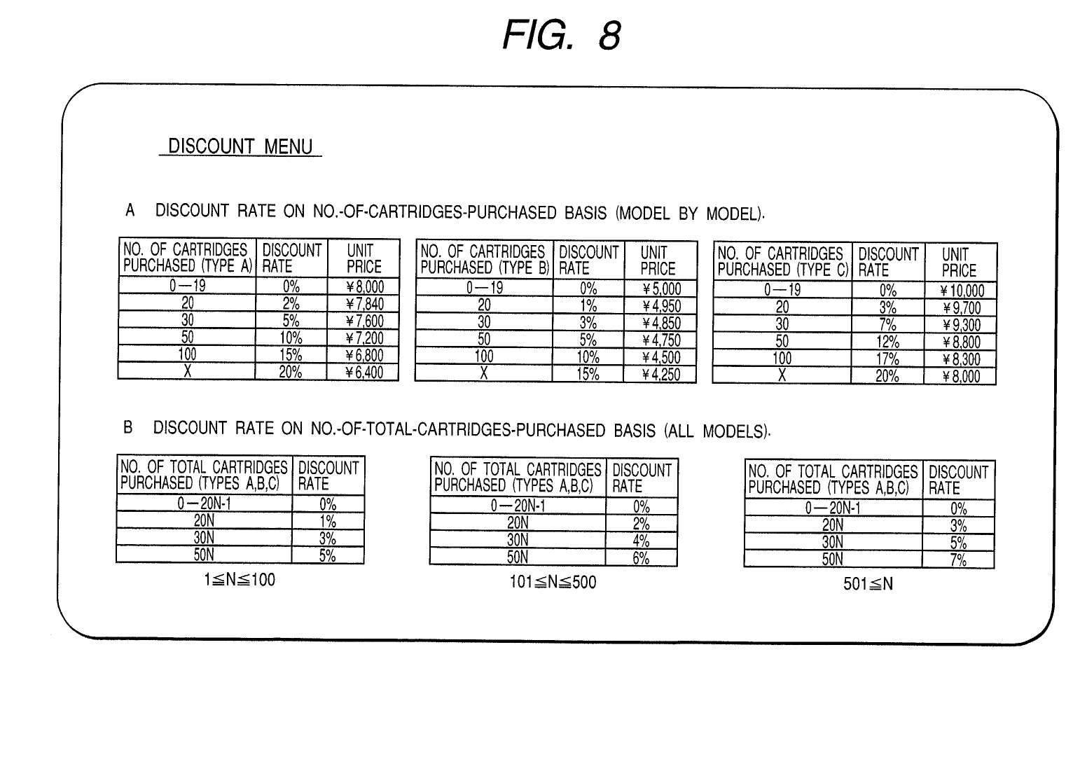

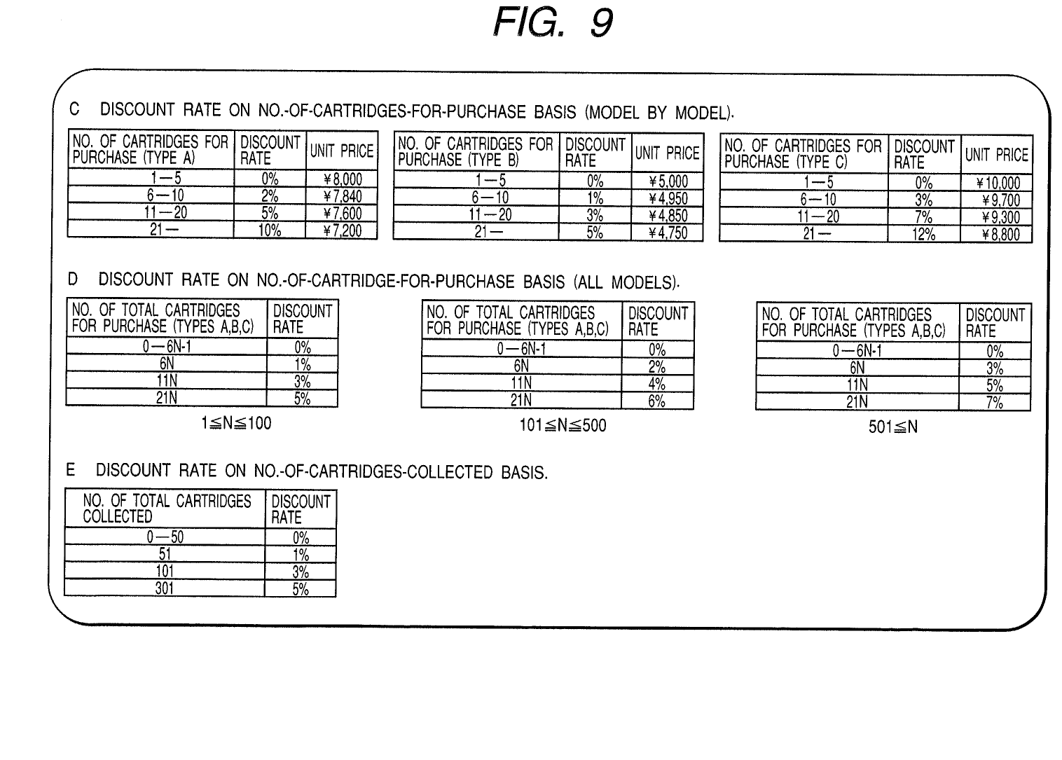

In FIG. 7, there are also shown buttons BT1 to BT3. In the following there will be explained, with reference to FIGS. 8 and 9, a discount rate that can be set on the toner cartridge discount menu.

It is also possible to execute the estimation, similar to the result shown in the section B in FIG. 7, by plural estimating methods without the designation by the user and to simultaneously display the results of such estimations, and, in such case the user can use the plural estimating methods as reference and can investigate the number of purchase more easily and more efficiently.

Also more efficient sales promotion to the user can be realized by informing the user of an estimation result allowing most inexpensive purchase among the results of calculation with the plural estimating methods in the server.

The plural estimating methods are not limited to those shown in the section A in FIG. 7, but any estimating method of higher precision may be preferably adopted.

FIGS. 8 and 9 show the discount rates settable in the toner cartridge discount menu presented to the manager apparatus in the server apparatus of the present invention. In FIG. 8, a section A shows an example of the discount rate according to the cumulative number of the toner cartridges for each model thereof. The user can purchase new cartridges with the discount rates shown in the table when the number of cartridges purchased reaches the numbers shown in the table for each model of the toner cartridge. A section B shows an example of the discount rate according to the cumulative purchased number of the total toner cartridges. The user can purchase new cartridges with the discount rate shown in the table, regardless of the model of the toner cartridge, when the total number of cartridges purchased reaches numbers shown in the table.

In FIG. 9, a section C shows an example of the discount rate according to the number of the purchased toner cartridges. The user can purchase new cartridges with the discount rates shown in the table according to the number of cartridges for purchase for each model of the toner cartridge. A section D shows an example of the discount rate according to the total number of the purchased toner cartridges. The user can purchase new cartridges with the discount rates shown in the table according to the total number of cartridges for purchase regardless of the model of the toner cartridge. A section E shows an example of the discount rate according to the number of toner cartridges collected. The user can purchase new cartridges with the discount rates shown in the table according to the total number of the cartridges collected regardless of the model of the toner cartridge. The values of the discount rate are determined according to the conditions of numbers shown in the table. There can also be conceived a system of combining the sections A to E in FIGS. 8 and 9, for example providing discount rates combining those according to the cumulative number of the toner cartridges for each model shown in the section A and those according to the number of the recovered toner cartridges shown in the section E. The result of calculation of such discount rates may be presented at the manager apparatus 103 or at a terminal apparatus provided at each sales shop.

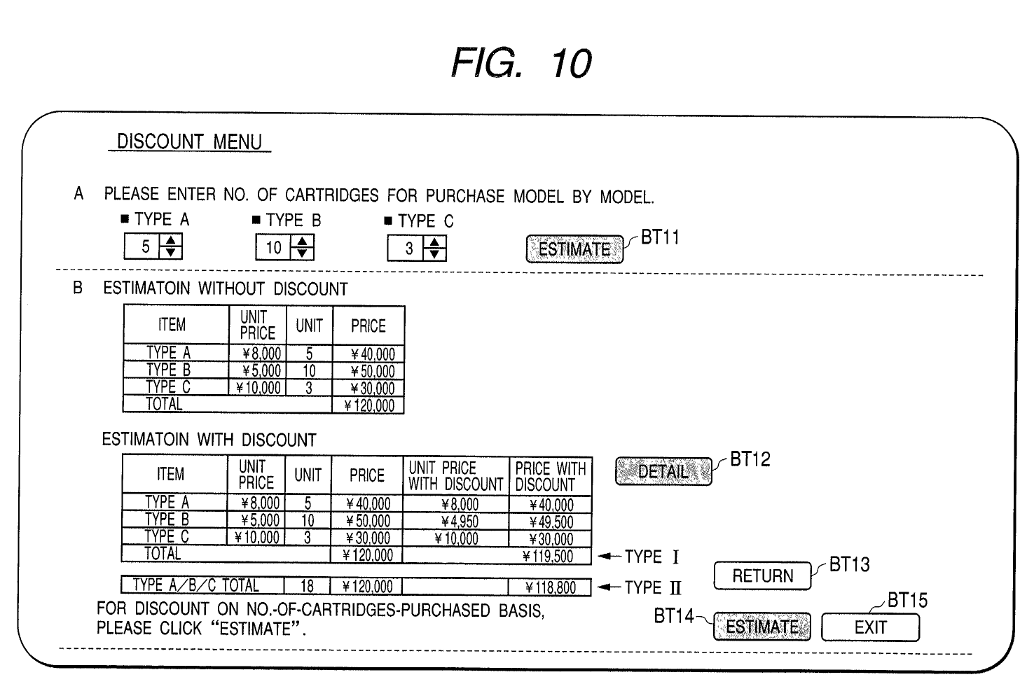

FIGS. 10 to 18 show an example of the toner cartridge discount menu presented to the manager apparatus in the server apparatus of the present invention.

In a state where an image shown in the section A in FIG. 10 is displayed on the manager apparatus 103 according to the toner cartridge discount menu presented from the main server 101, the user enters the number to be purchased for each cartridge type into the manager apparatus 103. The illustrated example shows a state of inputs of “5”, “10” and “3” for the different types. Then, in response to the entry of information indicating the depression of a button BT11 to the manager apparatus 103, information indicating the input numbers is transmitted through the internet to the main server 101, which, in response, transmits image information shown in the section B in FIG. 10 and corresponding to the result calculated by the main server 101 according to the received information to the manager apparatus 101 through the internet, whereby the display on the display unit of the manager apparatus is switched. In this manner, the manager can be presented with the result of discount estimated for the number of the cartridges to be purchased. In this state, the display can return to the number setting image shown in the section A in FIG. 10, in response to the entry of information, indicating the depression of a button BT13 into the manager apparatus 103. The number setting image shown in the section A in FIG. 10 may be restored by displaying image information as shown in the section A in FIG. 10, cached in advance in the manager apparatus or by requesting and obtaining image information as shown in the section A in FIG. 10 from the main server 101 through the internet.

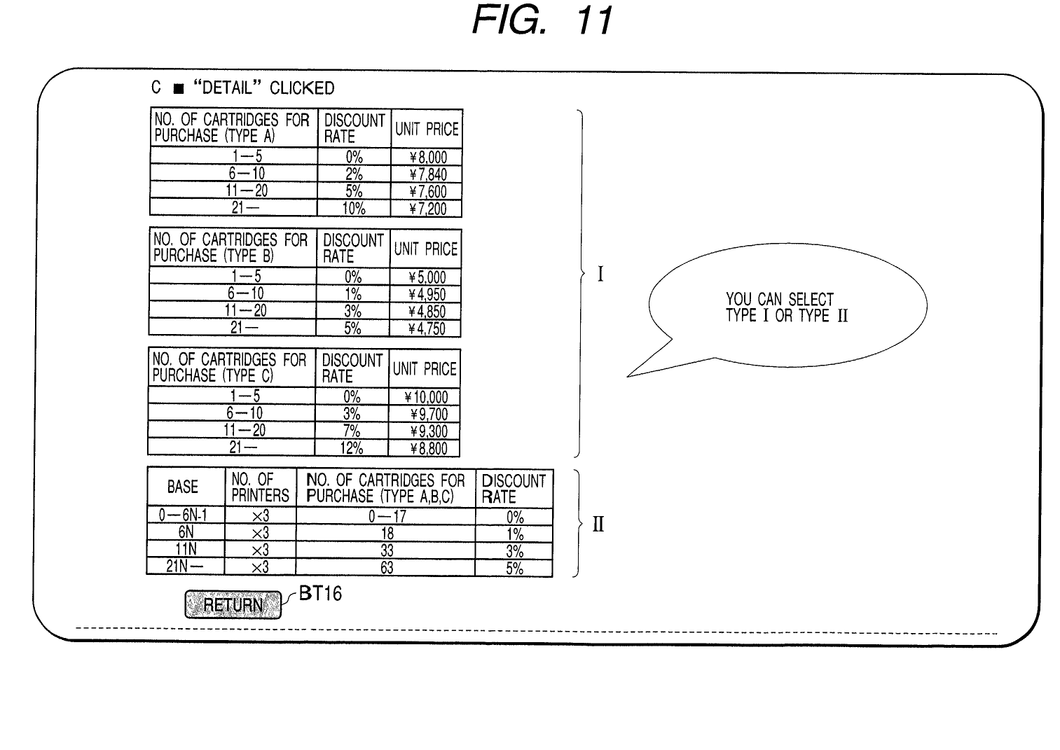

On the other hand, in the display state of the section B in FIG. 10, in response to the entry of information indicating the depression of a button BT12 into the manager apparatus 103, an image shown in FIG. 11 is transmitted from the main server 101 to the manager apparatus 103 and displayed on the display unit thereof. It is thus rendered possible to confirm the discount rates set for the number of purchase for each type. The display is switched to the image shown in the section B in FIG. 10 in response to the entry of information indicating the depression of a button BT16 into the manager apparatus 103.

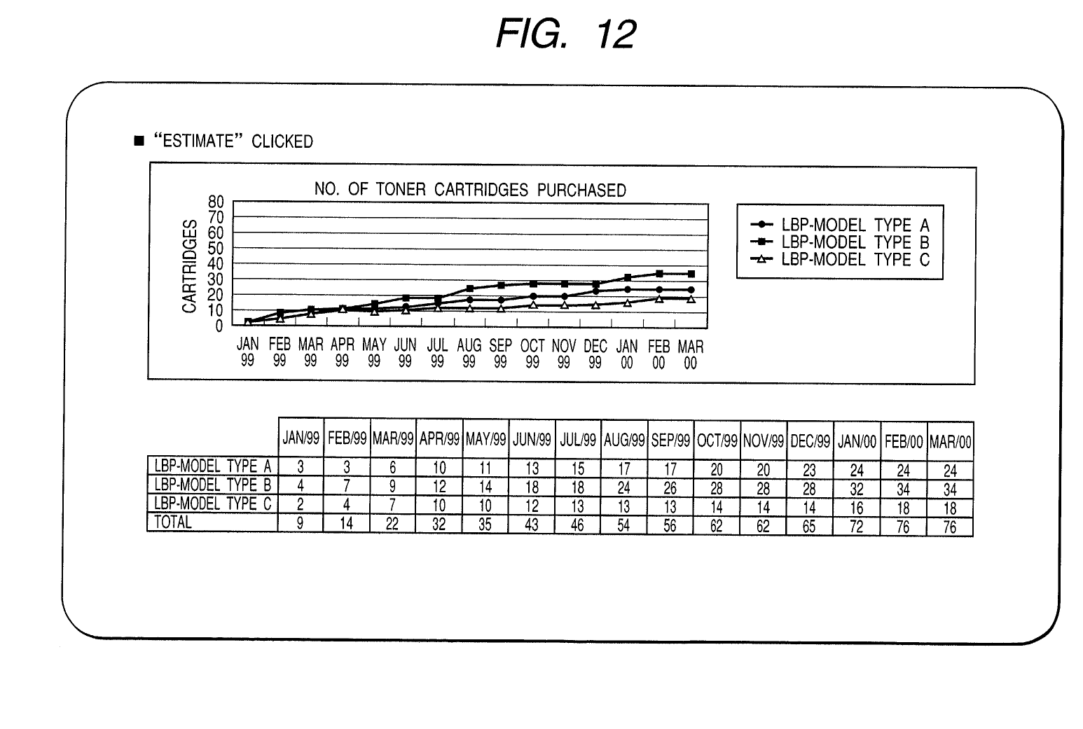

Also, in the display state of the section B in FIG. 10, in response to the entry of information indicating the depression of a button BT14 into the manager apparatus 103, an image shown in FIG. 12 is displayed on the display unit of the manager apparatus 103. There is thus displayed statistics information showing the cumulative number of the purchased toner cartridges for each user. In this manner it is rendered possible to recognize the discount rate adopted for the aforementioned estimation of the discount, among set discount rates.

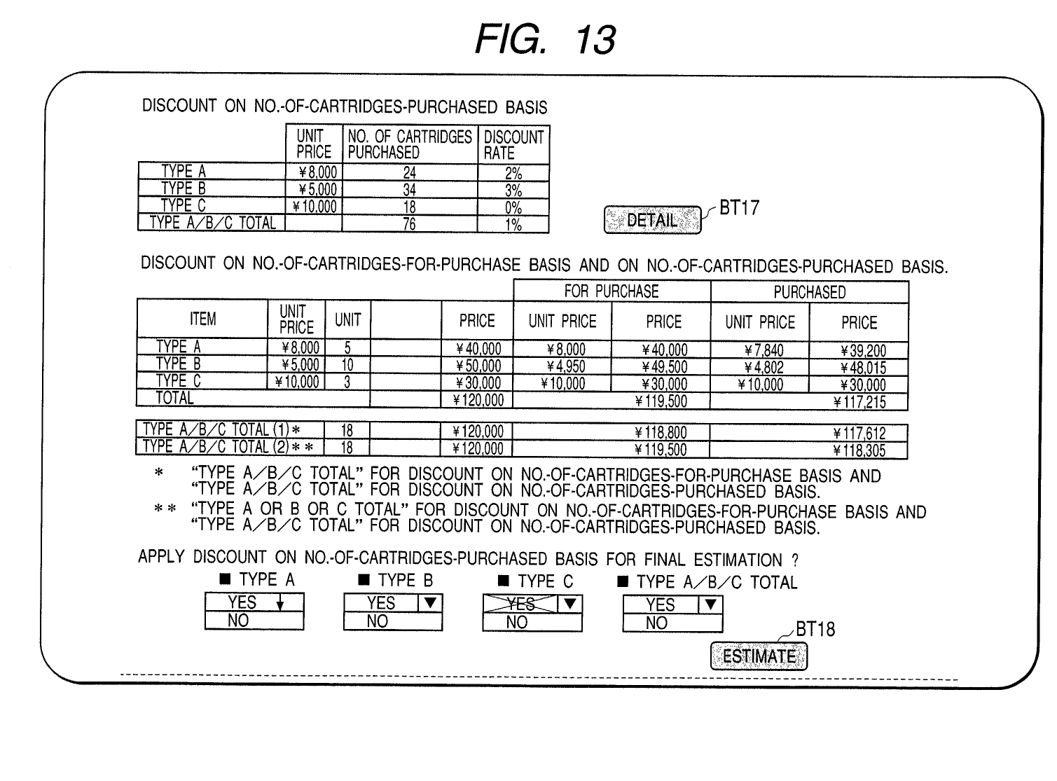

Then, in the display state of the section B in FIG. 10, in response to the entry of information indicating the depression of the button BT14 into the manager apparatus 103, an image shown in FIG. 13 is displayed on the display unit of the manager apparatus 103. Thus the user can confirm the example of estimation of the discount for the cumulative number for each type.

Also, in response to the entry of information indicating the depression of a button BT17 into the manager apparatus 103, there can be confirmed the result of estimation for number to be purchased (number set in the section A in FIG. 10) estimated from the discount rate based on the cumulative number. In the present embodiment, there is provided a check box allowing to designate, for each type, whether or not to apply the discount based on the cumulative number.

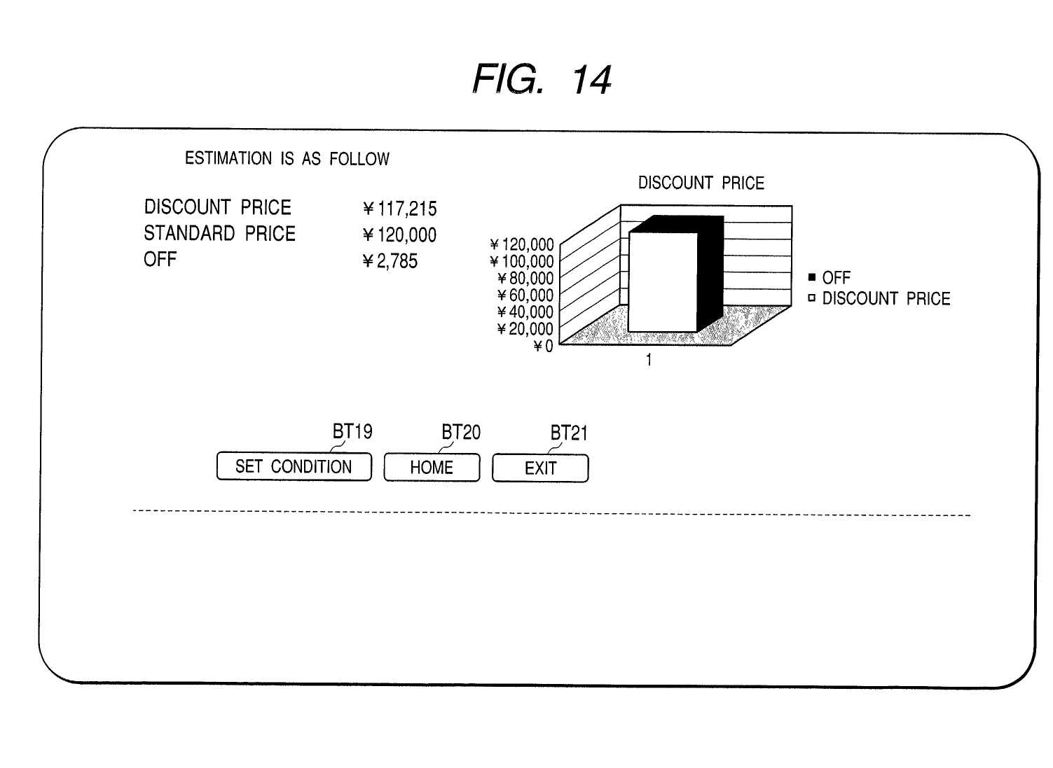

When a button BT18 is depressed, an image indicating the result of estimation based on the numulative number of purchase shown in FIG. 14 is displayed on the display unit of the manager apparatus 103. Thus the final purchase amount, the ordinary purchase amount and the discount amount can be evaluated in relative manner. In this state the purchase information is not entered into the order system, and the user can select either returning to the condition setting image, or returning to the initial state or terminating the estimation by respectively depressing buttons BT19 to BT21.

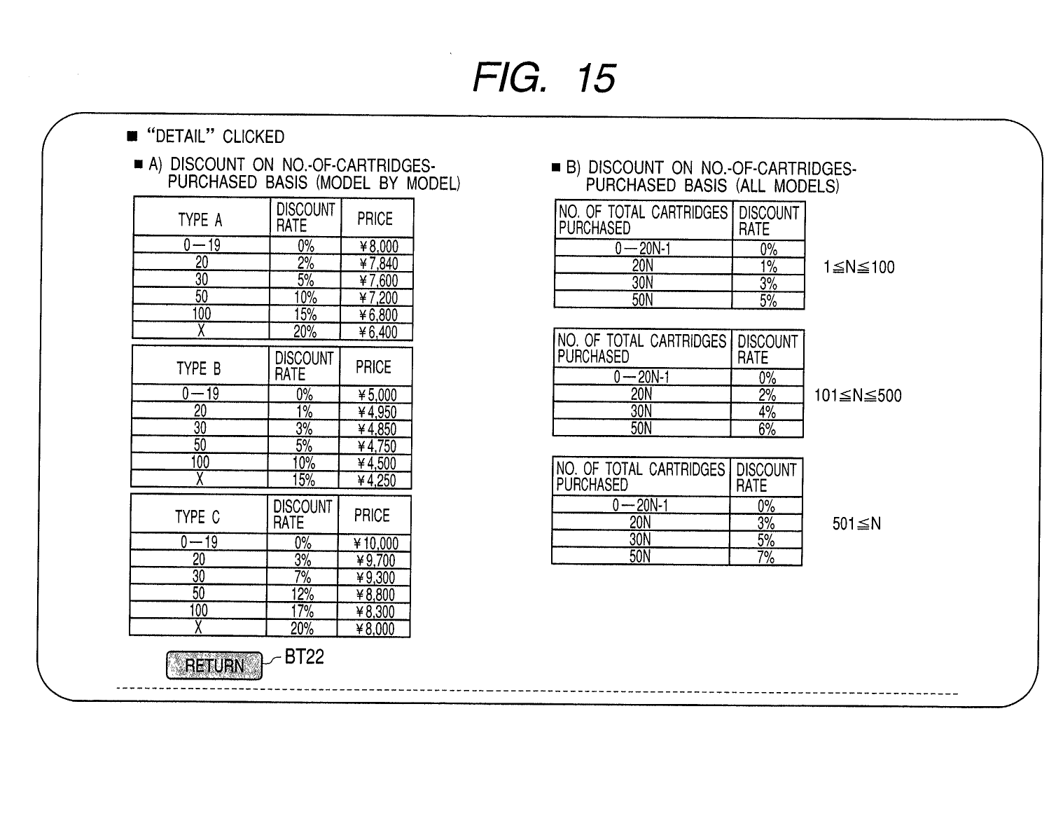

Also, in response to the depression of a button BT17 in the display state shown in FIG. 13, discount rates set at the estimation based on the cumulative number of purchase shown in FIG. 15 are displayed on the manager apparatus 103. In this state, in response to the depression of a button BT22, the display returns to the image shown in FIG. 13.

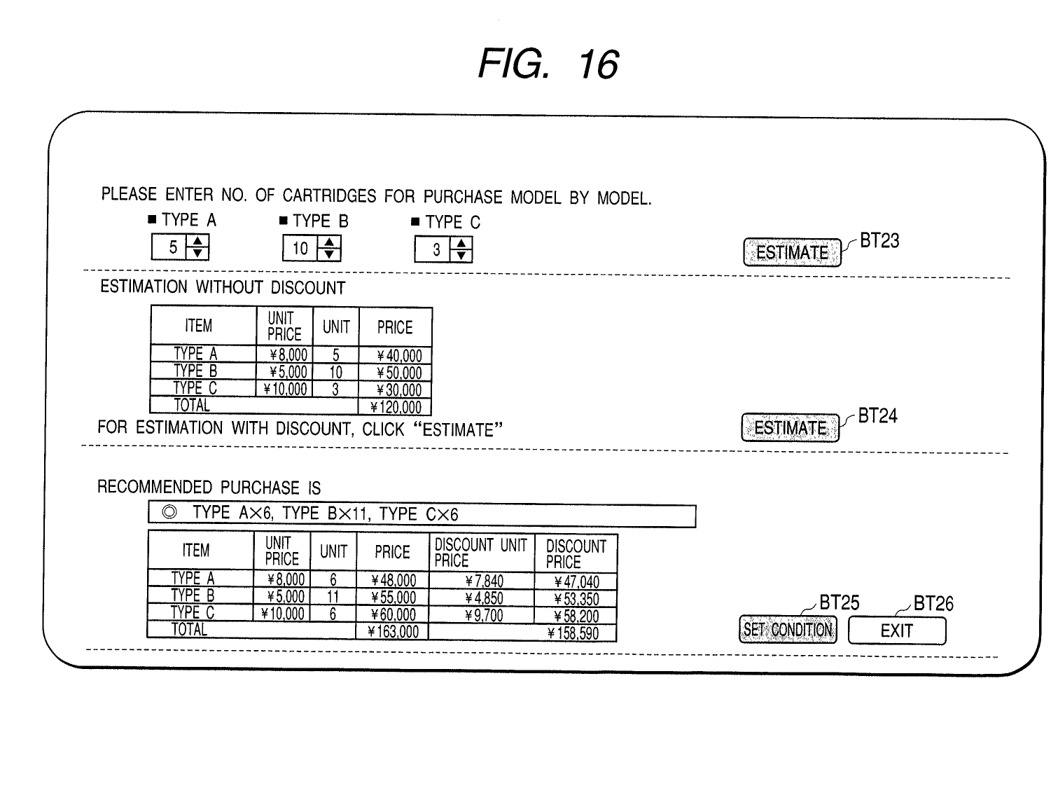

The toner cartridge discount menu process shown in FIGS. 10 to 15 have been explained by a simulation in which the manager executes estimations of various discounts by the ordinary menu process, but there may also be rendered selectable another menu shown in FIGS. 16 to 18 in addition to the menu shown in FIG. 10.

For example, in response to the depression of a button BT23 in a state where a menu image shown in FIG. 16 is displayed on the manager apparatus 103, the main server 101 executes a calculation process based on the depression information received through the internet and the result of such calculation is transmitted to the manager apparatus 103 and displayed on the display unit thereof. It is also possible to display an example of a favorable discount in response to the depression of a button BT24 in this state.

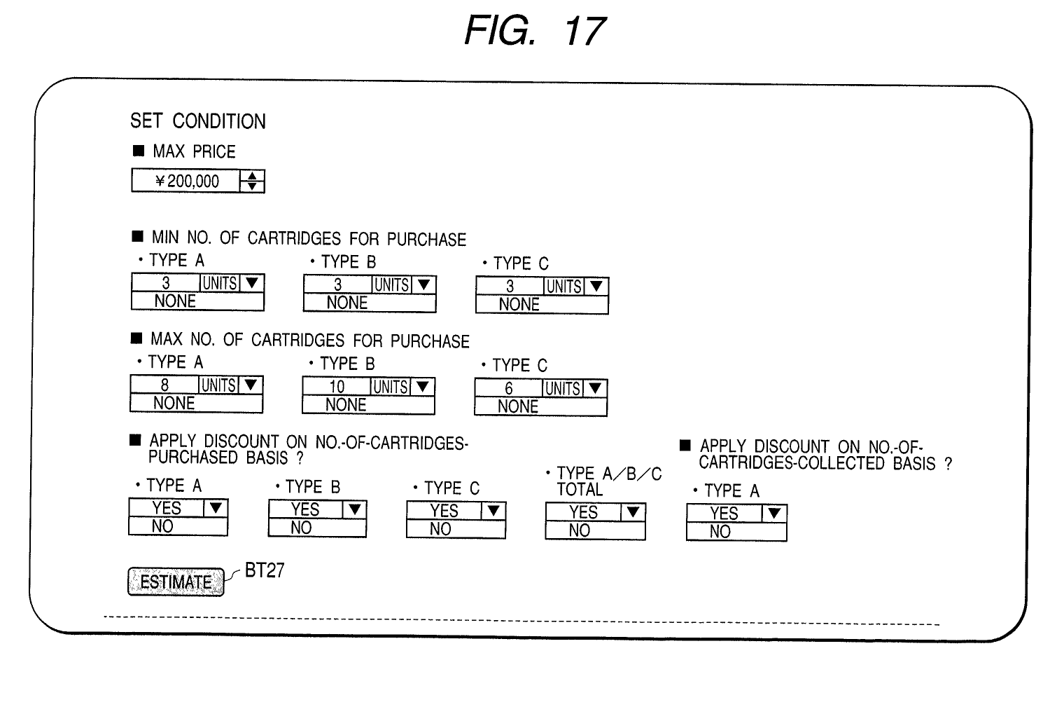

In this state, the present menu process is terminated in response to the depression of a button BT26, but, in response to the depression of a button BT25, a menu image for designating a search condition as shown in FIG. 17 is displayed on the manager apparatus 103.

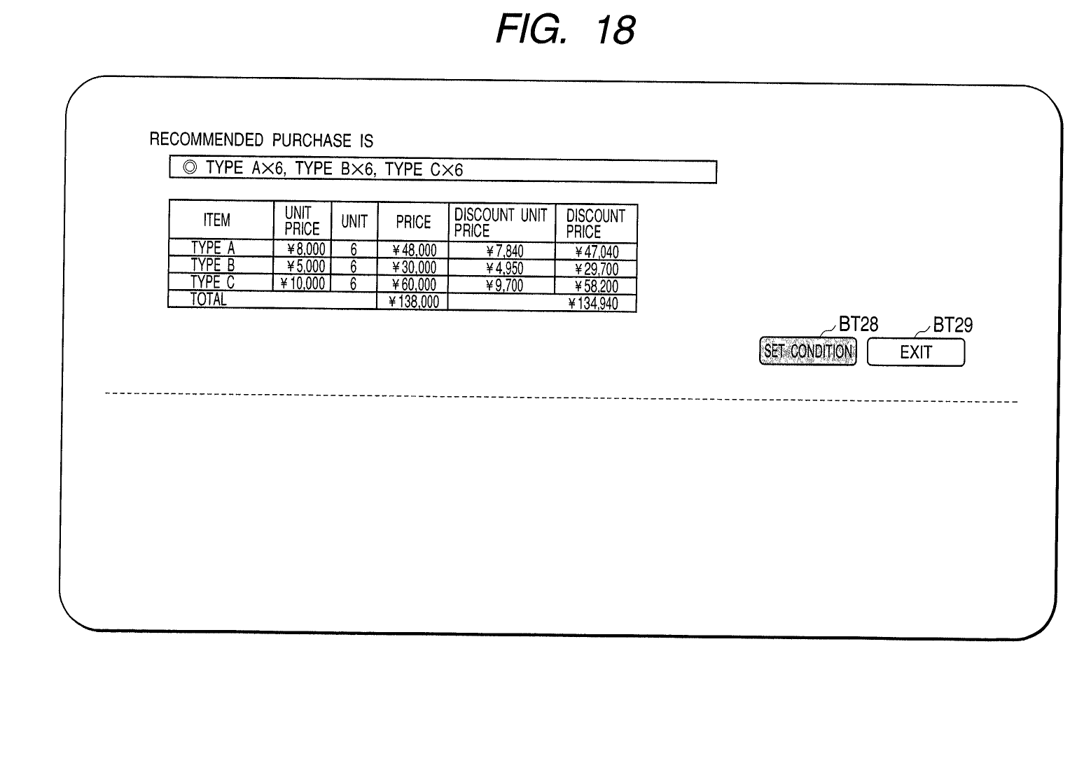

In this example, there can be arbitrarily set an upper limit for the purchase amount, an upper limit for the purchased number of the toner cartridges for each type, a lower limit for the purchased number of the toner cartridges for each type, and whether or not to apply the discount rate for the cumulative number of the purchased toner cartridges for each type. After the arbitrary setting of the search condition by the user, in response to the depression of a button BT27, an image recommending a result of estimation, corresponding to the taste of the use as shown in FIG. 18, is displayed on the manager apparatus 103.

In this state, the display returns to the image shown in FIG. 17 in response to the depression of a button BT28, but the menu process is terminated in response to the depression of a button BT29.

The switching of the display images shown in FIGS. 10 to 18 may be achieved either by transmitting new display information from the main server 101 through the internet to the manager apparatus 103 for display thereon at each switching, or by transmitting all the display information or a part thereof and a calculation program in the beginning from the main server 101 to the manager apparatus 103 and causing the manager apparatus 103 to control such image switching. Also returning to a previous image may be achieved by utilizing cached display information if it is cached in the manager apparatus 103.

In the following there will be explained, with reference to FIG. 27, an example of a process for generating plural discount menus according to the demand estimation determined in the server apparatus.

FIG. 27 is a flow chart showing an example of the process for generating the discount menu based on the demand forecast by the main server 101. Steps shown in FIG. 27 are realized by the CPU provided in the server apparatus (CPU 201 in FIG. 2), by reading a program stored in the memory unit (corresponding to ROM 203, HDD 213 etc. in FIG. 2 and executing such program.

At first, in a step S2701, the server apparatus receives log-in information transmitted from an information processing apparatus such as the manager apparatus 103 of the user side. The log-in information contains the password, user ID etc. of each user. Then, in a step S2702, the server apparatus reads the user and the history information managed corresponding to the user, based on the received information. The history information, read from the memory, includes the purchase history for each kind of the consumable, namely the number of purchase of each kind of the consumable, the state of utilization of the discount information, the replacement history for each kind of the consumable, the rate of use of the consumable etc.

Then, in a step S2703, there is received information indicating the period of use designated through the user interface as shown in the section A in FIG. 7, and, based on the received period information and the rate of use of the consumable read in the step S2702, there is calculated the number of the consumable necessary in the aforementioned term, namely the demand estimate information, which is transmitted to the information processing apparatus of the user side for display thereon. Such demand estimate is similar to what has been explained in the foregoing. For example by designating “3 months from the current month” in the input field “term” in the section A in FIG. 7 and “from the result in the same month previous year” in the input field “estimation from”, such selections are transmitted from the information processing apparatus (manager apparatus 103) of the user side to the main server 101, which calculates the demand estimate from the transmitted information.

Then a step S2704 calculates the discount rate and the discount price for the number of new purchase for each model, according to the demand estimate calculated in the step S2703. This calculation utilizes the table as shown in the section C in FIG. 9, stored in the memory unit of the server apparatus. In this manner the server apparatus generates information for informing the user of the discount service available for the new purchase of the consumable corresponding to the demand estimate.

Then a step S2705 calculates the discount rate and the discount price for the cumulative number of purchase for each model, including the demand estimate calculated in the step S2703. In the present embodiment, the cumulative number of purchase already subjected to the service will not be included in the cumulative number, and it is assumed that the user has not received the service for the cumulative number of purchase. It is naturally possible also to limit the service for the cumulative number of purchase for example to one year and to made such service available for any number of times, and such system is more advantageous for sales promotion. This calculation utilizes a table as shown in the section A in FIG. 8, stored in the memory unit of the server apparatus. Thus the server apparatus generates discount service information according to the number based on the demand estimate and the total cumulative number including the cumulative number of purchase for each model in the past.

In a step S2706, the server apparatus informs the user of the information generated in the steps S2704 and S2705, whereby the user can receives a desired discount service among the informed plural discount menus.

The kinds of the discount menus are not limited to those explained in FIG. 27, but various discount services may be provided to the user, utilizing a table for calculating plural discount rates (amounts) as shown in FIGS. 8 and 9. For example there can be provided a server apparatus capable for example of providing a system of referring to a table for calculating the discount rate (amount) according to the total number of cartridge purchase and the number of the print apparatus, namely including the number of the demand estimate in the total number of cartridge purchase, as shown in the section B in FIG. 8 or the section D in FIG. 9, or a system of referring to a table for calculating the discount rate (amount) in combination with the number of recovered cartridges as shown in the section E in FIG. 9. In this manner the user can receive a discount service according to the result of purchase and the result of recovery, that has not been available in the past.

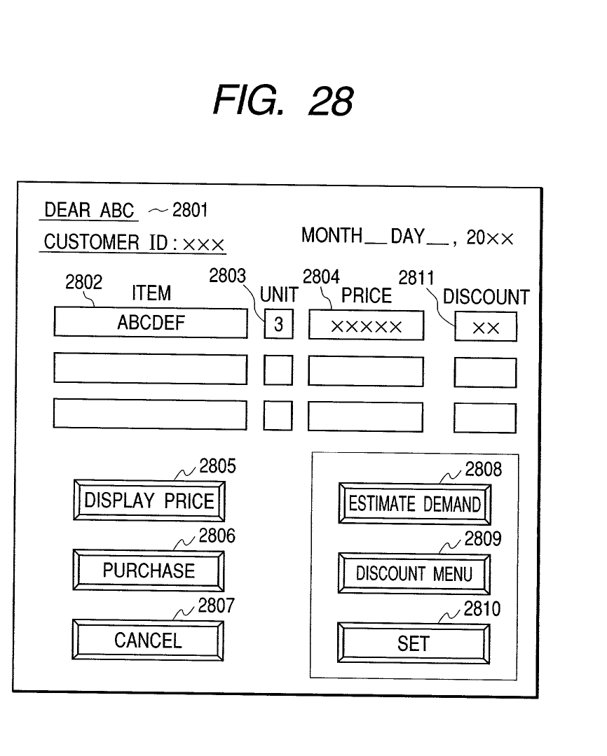

In the following there will be explained, with reference to FIG. 28, a user interface for requesting the above-explained displays from the information processing apparatus of the user side to the main server.

FIG. 28 shows the mode of display which can be browsed for example by the internet browser and which is provided from the main server 101 to the information processing apparatus of the client side in case the user ID or the password is transmitted for log-in from the information processing apparatus to the main server 101. In FIG. 28, a display 2801 indicates that the display mode is obtained as a result of the log-in operation of the information processing apparatus of the client side into the main server 101.

The display in FIG. 28 has the functions of placing order and browsing the discount information, whereby the user can easily browse the discount information and place an order.

There are provided an input field 2802 for ordering merchandises such as a cartridge, an input field 2803 for entering a quantity of order, a field 2804 for displaying price information corresponding to the data in the fields 2802, 2803, and a field 2811 for displaying discount information, which is calculated by the main server 101 as explained in the foregoing and informed to the information processing apparatus of the client side (for example manager apparatus 103). A price display request button 2805, when depressed, requests the main server 101 to calculate the discount information displayed in the field 2811.

A button 2806 is to inform the main server 101 that the merchandise, quantity, price and discount information as shown in FIG. 28 are accepted. A button 2807 is inform the main server 101 of a cancellation. The cancel button 2807 can also be used for instructing the information processing apparatus to clear the information entered into the fields 2082 to 2804 and 2811. A button 2808 is to request the demand estimate to the main server 101, and, when the depression of this button is transmitted to the main server 101, the main server 101 generates display image information as shown in FIGS. 5, 6 and 7 and transmits such information to the information processing apparatus of the client side. A button 2809 is to request a discount menu to the main server 101, and, when the depression of this button is transmitted to the main server 101, the main server 101 generates discount information specific to each user and informs the information processing apparatus of the client side of the information as shown in FIG. 13.

The system of discount information display in the field 2811 corresponds to the system enabling the blowing to the user in response to the depression of the discount menu button 2809. In case such system is changed, the depression information of a setting button 2810 may be transmitted to the main server 101 to display a discount setting image as shown in FIG. 7, 10, 13 or 16 on the information processing apparatus of the client side. In response to a change in the discount setting through thus displayed setting image, the discount information calculated by the main server 101 according to thus changed setting is informed to the information processing apparatus of the client side and displayed in the field 2811.

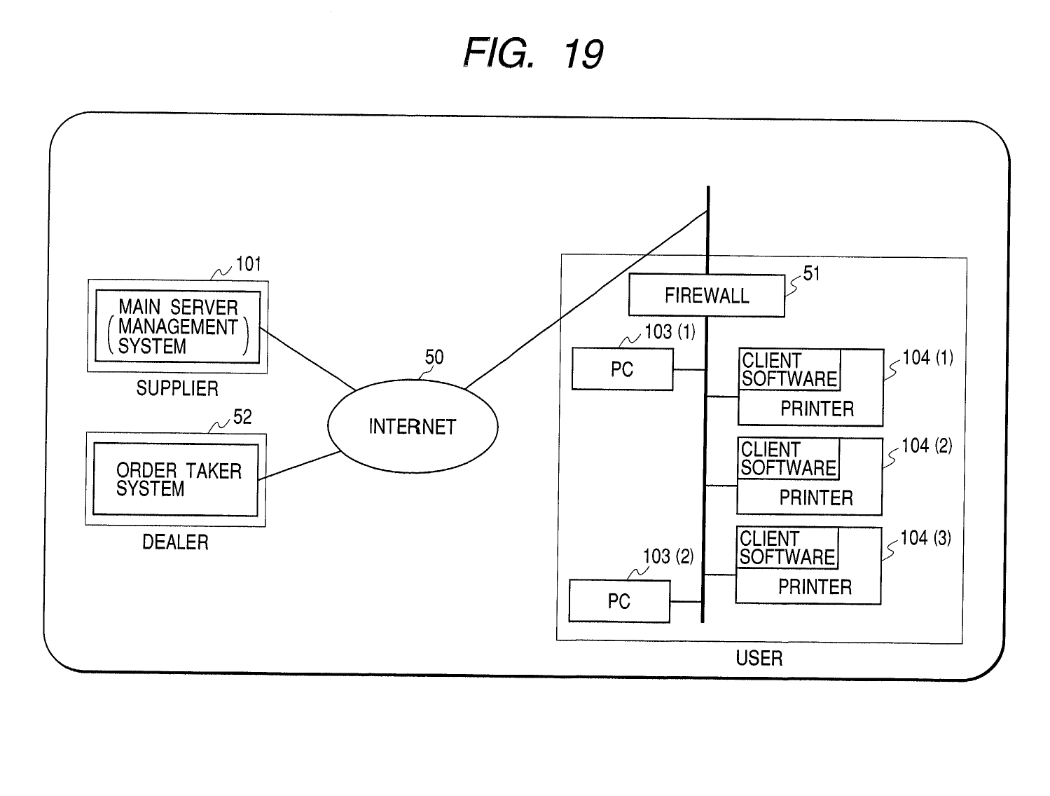

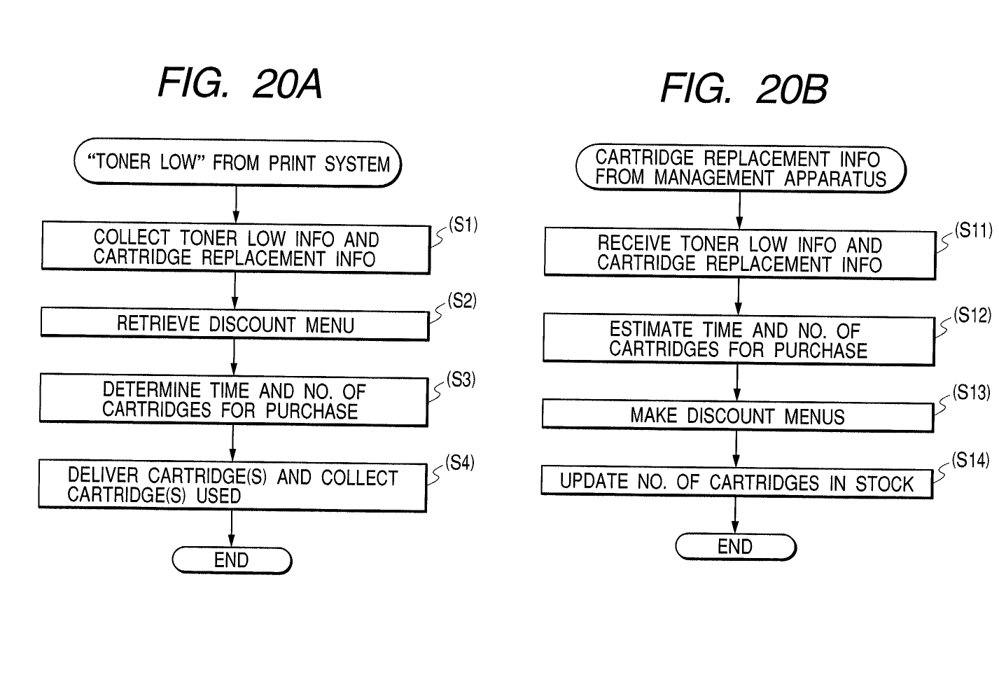

In the following there will be explained, with reference to FIGS. 19, 20A and 20B, a toner cartridge volume discount process by the server apparatus and the data processing apparatus of the present invention.

FIG. 19 is a block diagram showing an example of the toner cartridge volume discount process by an image processing network system in which the server apparatus (corresponding to the main server 101 in FIG. 1) and the data processing apparatus (corresponding to the manager apparatus 103) of the present invention are applicable, wherein components same as those in FIG. 1 are represented by same numbers.

Referring to FIG. 19, a firewall 51 is present between the network and other networks to limit improper access request. An order taking system 52 of the dealer side is composed of an ordinary computer system, and is rendered capable of communication by the internet protocol and through the internet 50, with the main server 101 and the manager apparatus 103 of the user side. The present example corresponds to a system in which the main server 101 of the manufacturer side comprehensively manages the toner cartridge volume discount process of the user side.

FIGS. 20A and 20B are flow charts showing an example of the data processing process in the network system in which the server apparatus and the data processing apparatus of the present invention are applicable, wherein the manager apparatus 103 and the main server 101 respectively constitute the data processing apparatus and the server apparatus shown in FIG. 26. FIGS. 20A and 20B respectively show the process of the manager apparatus 103 and that of the main server 101, wherein (S1) to (S4) and (S11) to (S14) indicate process steps.

At first, in response either to the reception of the low toner information by the manager apparatus 103(2) from any of the printer apparatus in the print systems 104(1) to 104(3) through the network 5, or to the reception of the cartridge replacement information, indicating the completed replacement of the toner cartridge from any of the printer apparatus, the manager apparatus 103(2) functioning as the toner cartridge count-up system counts, in a step (S1), the low toner information and the toner cartridge replacement information according to the ID of each printer. The customer information including the toner cartridge information, such as the toner cartridge replacements at least for each customer, is managed by a customer information storage 320 provided in the main server 101.

The manager apparatus 103(1) transmits the toner cartridge information, through the internet 50, to the main server 101, which, in response, the received information on the customer information storage 320.

Then, in a step (S2), a reception system 52 of the dealer side receives, through the internet 50, plural toner cartridge volume discount menus prepared for respective customers in a main server 505. Then, according to a predetermined time schedule, such plural toner cartridge volume discount menus are transmitted to the manager apparatus 103(1) through the internet 50.

Then, in a step (S3), the received toner cartridge volume discount menus are browsed to determine the actual number and timing of the purchase of the toner cartridges, and the thus determined number and timing of purchase of the toner cartridges are transmitted, as order information, from the manager apparatus 103(1) to the order taking system 52 through the internet 50.

Then, in a step (S4), upon delivery of the toner cartridges from the dealer to the customer by a delivery service or by a sales personnel, the remaining number of the toner cartridges etc. on the storage 320 is renewed, and transaction information indicating the order taking and delivery is transmitted from the manager apparatus 103(1) to the main server 101 through the internet 50, whereupon the process is terminated. At the delivery of the toner cartridges from the dealer by the delivery service or the sales personnel, there is executed the recovery of the used toner cartridges.

On the other hand, in response to the transmission of the toner cartridge information from the manager apparatus 103(1), the main server 101 receives, in a step (S11), such toner cartridge information by identifying the user by the IP address and the model information.

Then, in a step (S12), the main server 101 analyzes the customer information stored in the customer information storage 320 and the received toner cartridge information, and executes the estimation of the number and timing of the toner cartridges to be ordered by the user, based on the aforementioned demand estimate process.

Then, in a step (S13), the main server 101 generates plural toner cartridge volume discount menus by combining the calculated number and timing of the order of the toner cartridges with the cumulative number and timings of past purchases and transmits such menus to the reception system 52 of the dealer side through the internet 50. Thereafter, such plural toner cartridge volume discount menus are transmitted to the manager apparatus 103(1) through the internet 50 according a predetermined time schedule.

Then, in a step (S14), the customer information, such as the quantity of the toner cartridges held by each user, managed in the customer information storage 320 is updated according to the order taking/delivery information transmitted from the reception system 52 of the dealer side or the manager apparatus 103(1), whereupon the process is terminated.

According to the above-described embodiment, the main server 101 can automatically generate the toner cartridge purchase plan, which is to be prepared by the user of the manager apparatus side by recognizing the actual state of consumption of the toner cartridges, utilizing the low toner information and the toner cartridge replacement information generated in the print systems and transmitted through the internet, thereby providing a service useful for the purchase plan of the toner cartridges in exact and timely manner.

More specifically, it is rendered possible to prepare toner cartridge volume discount menus including a toner cartridge discount for a volume purchase, for a properly registered customer, based on the obtained customer information, thereby assisting the collective purchase plan in consideration of the budget of the manager and significantly alleviating the burden of the manager of the print systems in the toner cartridge management.

In the foregoing description, the means and functions of the customer information storage 320 and the volume discount menu generation means 314 are assumed to be included in the main server 101 as shown in FIG. 3, but the present invention is naturally applicable also to a configuration consisting of plural information processing apparatus (server apparatus), as long as the functional parts are mutually correlated. For example, the objects of the present invention can also be attained, in case the function of the volume discount menu generation means is given to an information processing apparatus capable of communicating with the main server 101 through a predetermined communication channel such as the internet. Also the components 310, 312, 314, 315, 320 and 321 shown in FIG. 3 may be similarly provided in external apparatus separate from the main server 101.

Second Embodiment

In the foregoing first embodiment, there has been explained a system in which the main server 101 functions as the management system, but it is also possible to add the management system in the order taking system 52 of the dealer side and to use the main server 101 as the count-up system, thereby alleviating the burden of data processing therein.

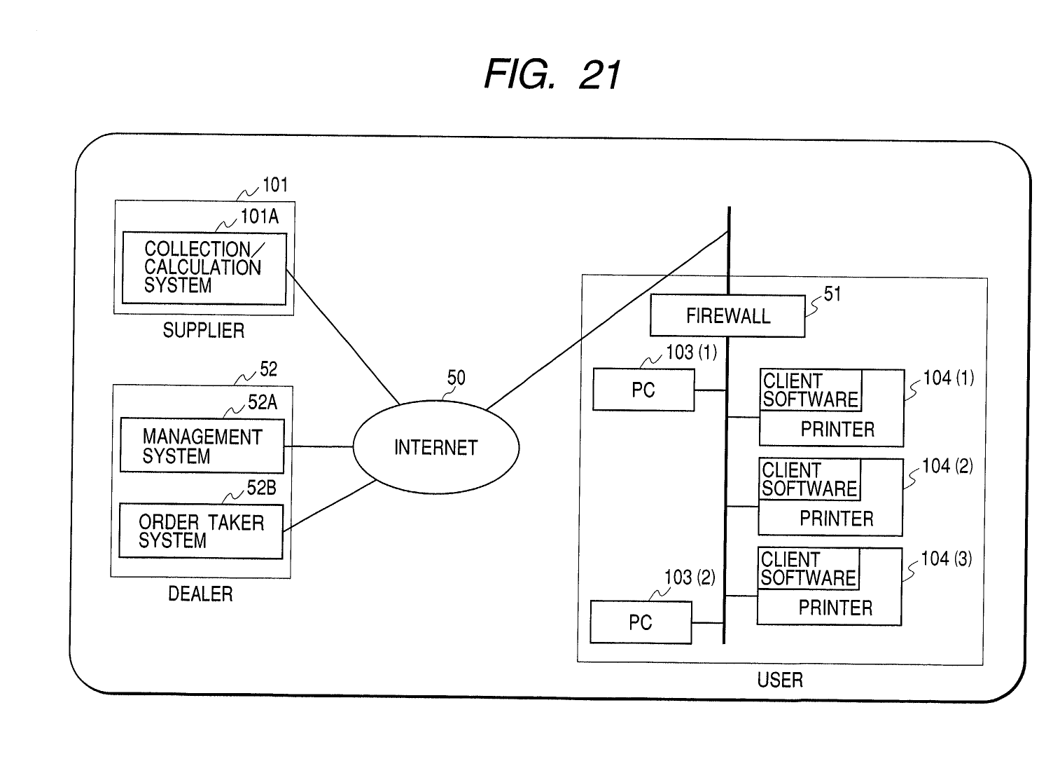

FIG. 21 is a block diagram showing the configuration of a print process system in which the server apparatus, print apparatus and data processing apparatus of a second embodiment of the present invention are applicable, wherein components same as those in FIG. 1 are represented by same numbers. The first and second embodiments are same except that the function of the management system, within the functions of the main server 101,namely the process of generating the toner cartridge discount menu including the toner cartridge volume discount for the properly registered user, based on the obtained customer information, is executed by the order taking system 52.

At first, the low toner information and the toner replacement information from the print systems 104(1) to 104(3) are informed to the manager apparatus 103(2) and are counted.

Then the manager apparatus 103(2) functioning as the toner cartridge count-up system informs the management system of the sales (dealer) shop of the counted information through the internet 50. The management system 52A executes estimation of the optimum number and timing of the toner cartridges to be ordered by the user, based on the information from the manager apparatus 103(2) constituting the toner cartridge count-up system of the user side and the information informed from the toner cartridge count-up system 101A and accumulated in the past.

Then the management system 52A of the sales shop generates a volume discount menu by combining the thus estimated number/timing and the cumulative number/timing of the toner cartridges purchased by the user in the past.

Then an order taking system 52B of the sales shop informs the estimated volume discount menu to the person of the user in charge of the toner cartridge purchase, through the internet 50. Then the person in charge places an order for the toner cartridges based on the information informed from the order taking system 52B of the sales shop.

Then the sales shop delivers the ordered toner cartridges to the user and recovers the used toner cartridges. Then the management system 52A of the sales shop informs,through the internet 50, the count-up system 101A in the main server 101 of the manufacturer side of the number of cartridges held by the user, the number ordered and the estimated timing of cartridge ordering.

Third Embodiment

In the foregoing first embodiment, there has been explained a system in which the main server 101 functions as the management system, but it is also possible to execute the services such as the toner cartridge management and the toner cartridge discount on the web.

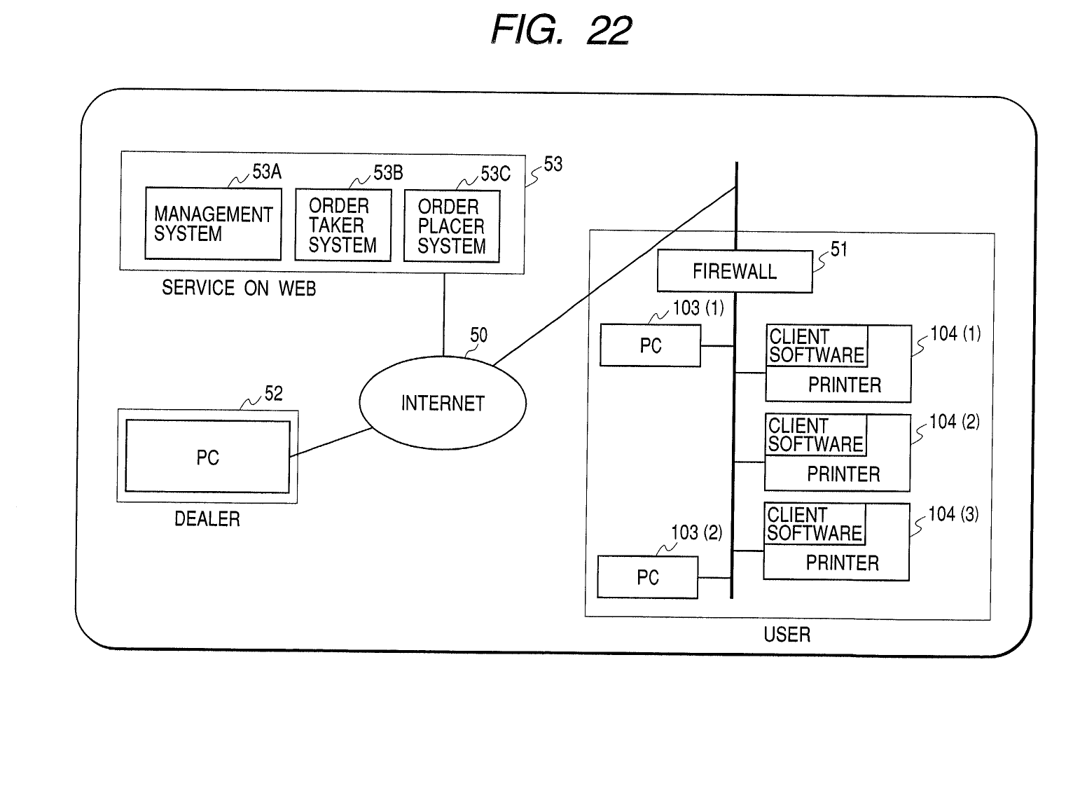

FIG. 22 is a block diagram showing the configuration of a print process system in which the server apparatus, print apparatus and data processing apparatus of a third embodiment of the present invention are applicable, wherein components same as those in FIG. 1 are represented by same numbers. The first and third embodiments are different in that the process of generating the toner cartridge discount menu including the toner cartridge volume discount for the properly registered user, based on the obtained customer information, is executed on the web. In FIG. 22, there is also shown an ordering system 53C.

At first, the low toner information and the toner replacement information from the print systems 104(1) to 104(3) are informed to the manager apparatus 103(2) and are counted.

Then the manager apparatus 103(2) functioning as the toner cartridge count-up system informs the manager system 103(1) of the counted information.

Then the manager apparatus 103(1) executes log-in to a service operated by a sales company on the web, and informs a management system 53A on the web of the information counted by the manager apparatus 103(2).

The management system 53A on the web executes estimation of the optimum number and timing of the toner cartridges to be ordered by the user, based on the information from the manager apparatus 103(1) of the user side and the information informed therefrom and accumulated in the past.

Then the management system 53A on the web generates a volume discount menu by combining the thus estimated number/timing and the cumulative number/timing of the toner cartridges purchased by the user in the past.

Then an order taking system 53B on the web informs the estimated volume discount menu to the manager apparatus 103(1) of the user, through the internet 50. Then the manager apparatus 103(1) places an order for the toner cartridges based on the information informed from the order taking system 53C on the web and utilizing the ordering system 53B on the web.

Then the order taking system 53B on the web informs a sales shop of the quantity/timing ordered by the user, and the sales shop delivers the ordered toner cartridges to the user and recovers the used toner cartridges.

Then the sales shop informs the management system on the web of the information on the number/delivery ordered from the user, and the management system 53A on the web updates the information on the number of cartridges held by the user based on such number/delivery information, whereupon the process is terminated.

Fourth Embodiment

In the foregoing, there have been explained cases where the present invention is applied to a print system utilizing a toner cartridge, properly supplied by the manufacturer and provided with a non-volatile memory 42 as shown in FIG. 4. In such proper toner cartridge equipped with the non-volatile memory 42, upon mounting on the main body of the printer, a flat indicating the mounting on the printer is set in such non-volatile memory 42, so that the number of replacement of the toner cartridge is not counted excessively but regarded as “1” even in case the same toner cartridge is removed from the main body and mounted again, but, in a toner cartridge without the non-volatile memory 42, if once extracted from the main body, the number of replacement of the toner cartridge is counted up so that the basic parameter to be used in the volume discount menu becomes erroneous and a large error is generated in the demand estimation.

In the present embodiment, therefore, the number of replacements of the toner cartridge is judged incorrect in case the difference between the cumulative number of purchase of the toner cartridges and the number of replacements thereof becomes negative, and, in such case there is presented to the user a request for entering the number of toner cartridges in inventory and the number of replacement of the toner cartridges is obtained from the entered number and the cumulative number of purchase of the toner cartridges thereby suppressing the error in estimation. The menu in such embodiment will be explained in the following.

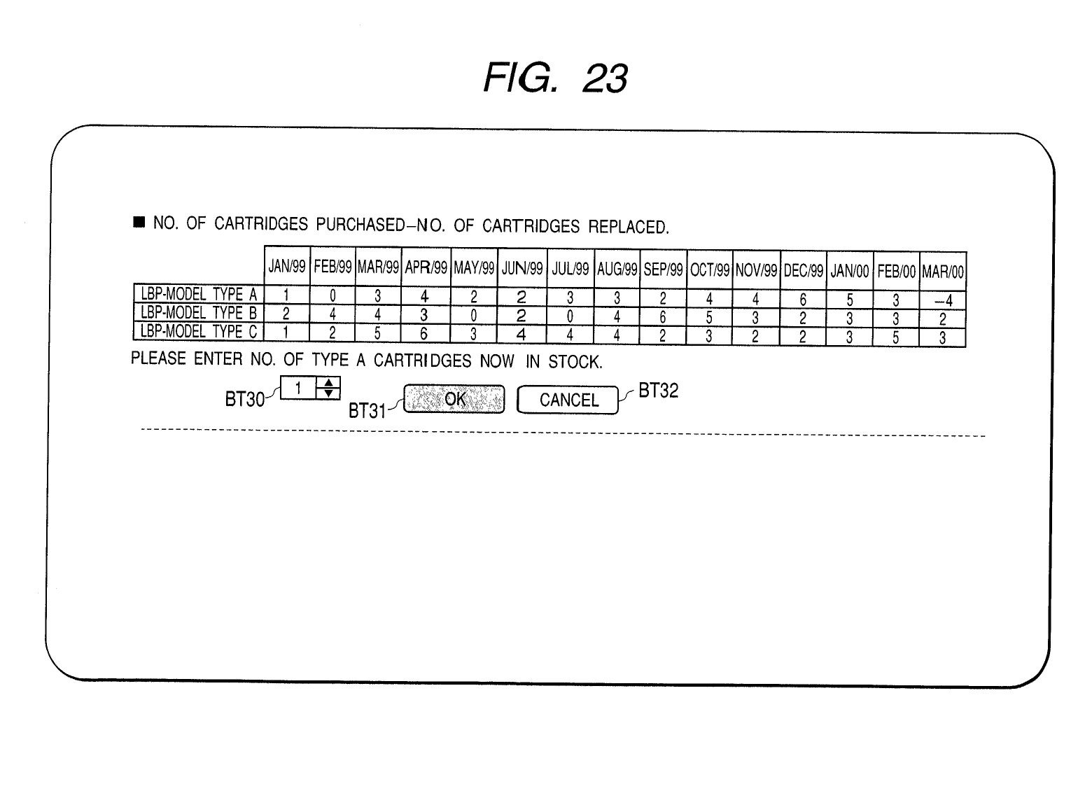

FIG. 23 is a view showing an example of demand estimation menu in a print process system in which the server apparatus, print apparatus and data processing apparatus of a fourth embodiment of the present invention are applicable.

A count button BT30 is used for entering the number of toner cartridges in inventory, and a button BT31 is used for establishing the number in inventory while a button BT32 is used for canceling such number in inventory.

In case the number of replacements of the toner cartridge is judged incorrect from a fact that the difference between the cumulative number of purchase of the toner cartridges and the number of replacements of the toner cartridge becomes negative, there is presented to the user a request for entering the number of toner cartridges in inventory, and the number of replacements of the toner cartridge is obtained from the entered number and the cumulative number of purchase of the toner cartridges thereby suppressing the error in estimation.

Fifth Embodiment

In the foregoing embodiments, there has been explained cases where the date and time for providing the volume discount service are not particularly specified. However, since the accounting term varies from user to user utilizing the print system, it is also possible to enable designation and registration of the date and time for providing the volume discount service, in order to meet the advantage of such users. In the following there will be explained an example of the registration designating menu in such embodiment.

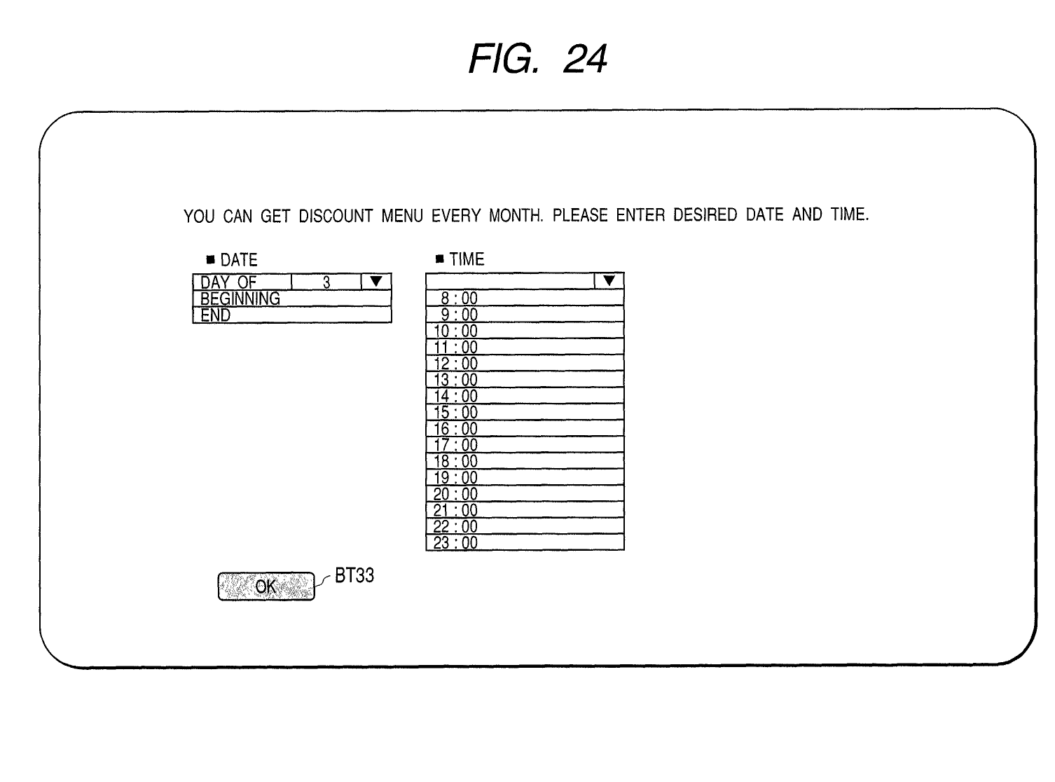

FIG. 24 is a view showing an example of a registration menu for designating the date and time for providing the volume discount service, the state of use of toner cartridges and the demand estimate in a print process system in which the server apparatus, print apparatus and data processing apparatus of a fifth embodiment of the present invention are applicable. Such menu is displayed on the display device of the manager apparatus 103(1) shown in FIG. 1 by a service program installed therein.

In FIG. 24, a button BT33 is depressed in designating the provision of the volume discount service at preset date and time, and the entered information is informed through the internet 50 to the main server 101 and is stored and managed therein for each user.

In this manner the volume discount service can be provided matching the accounting schedule of the user, even if the accounting term is different from user to user utilizing the print system.

It is also possible to attach so-called mail service to the information of the volume discount service and to cause a link button, provided in such mail, to download the volume discount menu, thereby securely and timely informing the user of the manager apparatus 103(1) of the period of the volume discount service.

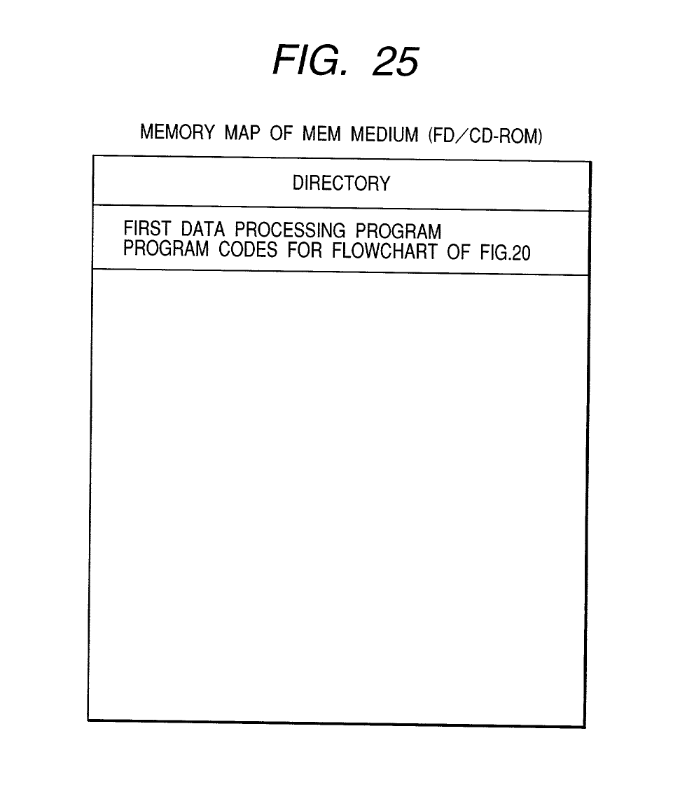

In the following there will be explained, with reference to a memory map shown in FIG. 25, the configuration of a data processing program readable by the print process system in which the server apparatus, print apparatus and data processing apparatus of the present invention are applicable.

FIG. 25 is a memory map of a memory medium storing a data processing program readable by the print process system in which the server apparatus, print apparatus and data processing apparatus of the present invention are applicable.

Though not particularly illustrated, there may also be stored information for managing the programs stored in the memory medium, such as version information and program author, and also information dependent on the operating system of the program reading side such as an icon for identifying and presenting the program.

Also data belonging to various programs are managed by the directory mentioned above. There may also be stored a program for installing various programs into the computer and a thawing program for expanding the program in case it is compressed.

Functions of the present embodiment, shown in FIG. 20, may be executed by a host computer by a program installed from the exterior. The present invention is applicable also to a case where the information including the program is supplied to an output apparatus from a memory medium such as a CD-ROM, a flush memory or an FD or from an external memory medium through the network.

The objects of the present invention can naturally be attained also in a case where a memory medium storing program codes of a software realizing the functions of the aforementioned embodiments is supplied to a system or an apparatus and a computer (or CPU or MPU) of such system or apparatus reads and executes the program codes stored in the memory medium.

In such case, the program codes themselves read from the memory medium realize the novel functions of the present invention, and the memory medium storing the program codes constitutes the present invention.n The memory medium for supplying the program codes can be, for example, a floppy disk, a hard disk, an optical disk, a magnetooptical disk, a CD-ROM, a CD-R, a magnetic tape, a non-volatile memory card, a ROM or an EEPROM.

The present invention naturally includes not only a case where the functions of the aforementioned embodiments are realized by the execution of the read program codes by the computer but also a case where an operating system or the like functioning on the computer executes all the processes or a part thereof according to the instructions of such program codes, thereby realizing the functions of the aforementioned embodiments.

The present invention further includes a case where the program codes read from the memory medium are once stored in a function expansion board inserted into the computer or in a function expansion unit connected thereto and a CPU or the like provided in such function expansion board or unit executes all the processes or a part thereof according to the instructions of such program codes, thereby realizing the functions of the aforementioned embodiments.

The foregoing embodiments have been explained by taking the toner cartridge as an example, but the present invention is not limited to such example and is applicable also to all the consumables such as ink cartridge, photosensitive drum cartridge, recording sheet etc.

According to the server apparatus, toner cartridge management method and memory medium of the present invention, as explained in the foregoing, there are executed to manage the customer information by obtaining the toner cartridge information managed by the data process apparatus, to calculate the demand estimate for the toner cartridge by analyzing the toner cartridge information in the managed customer information, to generate plural toner cartridge volume discount menus respectively different for the users based on thus calculated demand estimate of the toner cartridge and to inform the data processing apparatus of such plural toner cartridge volume discount menus, whereby the toner cartridge purchase plan, which is to be prepared by the user of the manager apparatus side by recognizing the actual state of consumption of the toner cartridges can be automatically generated, utilizing the low toner information and the toner cartridge replacement information generated in the print systems and transmitted through the internet, thereby providing a service useful for the purchase plan of the toner cartridges in exact and timely manner.

Consequently,it is rendered possible to prepare toner cartridge volume discount menus including a toner cartridge discount for a volume purchase, for a properly registered customer, based on the obtained customer information, thereby assisting the collective purchase plan in consideration of the budget of the manager and significantly alleviating the burden of the manager of the print systems in the toner cartridge management.

Also according to the server apparatus, toner cartridge management method and memory medium of the present invention, as explained in the foregoing, there are executed to collect and store the toner cartridge information based on the toner cartridge control information informed from the print apparatus, to transfer the toner cartridge information stored in the memory means to the server apparatus based on the request from the server apparatus for obtaining the toner cartridge information, then to obtain the toner cartridge volume discount menu informed from the server apparatus, to display the obtained toner cartridge volume discount menu on the display unit for browsing, to designate the displayed toner cartridge volume discount menu and to issue the order for purchasing the toner cartridge volume discount according to such designation to the server apparatus, whereby the toner cartridge purchase plan, which is to be prepared by the user of the manager apparatus side by recognizing the actual state of consumption of the toner cartridges can be automatically generated, utilizing the low toner information and the toner cartridge replacement information generated in the print systems and transmitted through the internet, thereby providing a service useful for the purchase plan of the toner cartridges in exact and timely manner.

Consequently,it is rendered possible to prepare toner cartridge volume discount menus including a toner cartridge discount for a volume purchase, for a properly registered customer, based on the obtained customer information, thereby assisting the collective purchase plan in consideration of the budget of the manager and significantly alleviating the burden of the manager of the print systems in the toner cartridge management.

What is claimed is:

1. A server apparatus capable of managing, through internet, customer information utilizing a data processing apparatus for managing toner cartridge information obtained by communication with a printing apparatus capable of recognizing a mount state and a replacement state of a toner cartridge mounted thereon, the server apparatus comprising:
management means for managing the customer information by obtaining said toner cartridge information managed by said data processing apparatus;
estimation means for calculating a demand estimate for the toner cartridge by analyzing said toner cartridge information in the customer information managed by said management means;
generation means for generating plural toner cartridge volume discount menus respectively different for the customers, based on the demand estimate for the toner cartridge calculated by said estimation means; and
informing means for informing said data processing apparatus of the plural toner cartridge volume discount menus generated by said generation means.

2. A server apparatus according to claim 1, further comprising:
obtaining means for obtaining an order request entered from said data processing apparatus according to any of the toner cartridge volume discount menus informed by said informing means; and
renewal means for renewing said toner cartridge information in said customer information, based on the order request obtained by said obtaining means.

3. A server apparatus according to claim 1, wherein said generation means generates plural toner cartridge volume discount menus respectively different for the users and derived with a discount rate according to the cumulative number of purchase for each toner cartridge model, based on the demand estimate for the toner cartridge calculated by said estimation means.

4. A server apparatus according to claim 1, wherein said generation means generates plural toner cartridge volume discount menus respectively different for the users and derived with a discount rate according to the total cumulative number of purchase of the toner cartridge, based on the demand estimate for the toner cartridge calculated by said estimation means.

5. A server apparatus according to claim 1, wherein said generation means generates plural toner cartridge volume discount menus respectively different for the users and derived with a discount rate according to the number of purchase for each toner cartridge model, based on the demand estimate for the toner cartridge calculated by said estimation means.

6. A server apparatus according to claim 1, wherein said generation means generates plural toner cartridge volume discount menus respectively different for the users and derived with a discount rate according to the total number of purchase for the toner cartridge, based on the demand estimate for the toner cartridge calculated by said estimation means.

7. A server apparatus according to claim 1, wherein said generation means generates plural toner cartridge volume discount menus respectively different for the users and derived with a discount rate according to the number of recovered toner cartridge, based on the demand estimate for the toner cartridge calculated by said estimation means.

8. A server apparatus according to claim 1, wherein said generation means generates a toner cartridge volume discount menu to be recommended to each user, based on the demand estimate for the toner cartridge calculated by said estimation means.

9. A server apparatus according to claim 1, wherein said estimation means executes a predetermined corrective calculation in the demand estimation for the toner cartridge, based on the result of analysis of said toner cartridge information in the customer information managed by said management means.

10. A server apparatus according to claim 1, wherein said informing means informs said data processing apparatus, at designated date and time, of the plural toner cartridge volume discount menus generated by said generation means.

11. A data processing apparatus capable of informing a server apparatus, through internet, of toner cartridge information obtained by communication with a printing apparatus capable of recognizing a mount state and a replacement state of a toner cartridge mounted thereon, the data processing apparatus comprising:
memory means for collecting and storing the toner cartridge information based on toner cartridge control information informed from said print apparatus;
transfer means for transferring said toner cartridge information stored in said memory means to said server apparatus;
obtaining means for obtaining a toner cartridge volume discount menu informed from said server apparatus;
display control means for causing a display unit to display for browsing the toner cartridge volume discount menu obtained by said obtaining means;
designation means for designating the toner cartridge volume discount menu displayed for browsing by said display control means; and
issuing means for issuing a request for purchase of the toner cartridge volume discount to said server apparatus, according to the designation by said designation means.

12. A toner cartridge management method for use in a server apparatus capable of managing, through internet, customer information utilizing a data processing apparatus for managing toner cartridge information obtained by communication with a printing apparatus capable of recognizing a mount state and a replacement state of a toner cartridge mounted thereon, the method comprising:
a management step of managing the customer information by obtaining said toner cartridge information managed by said data processing apparatus;
an estimation step of calculating a demand estimate for the toner cartridge by analyzing said toner cartridge information in the customer information managed by said management step;
a generation step of generating plural toner cartridge volume discount menus respectively different for the customers, based on the demand estimate for the toner cartridge calculated by said estimation step; and
an informing step of informing said data processing apparatus of the plural toner cartridge volume discount menus generated by said generation step.

13. A method according to claim 12, further comprising:
an obtaining step of obtaining an order request entered from said data processing apparatus according to any of the toner cartridge volume discount menus informed by said informing step; and
a renewal step of renewing said toner cartridge information in said customer information, based on the order request obtained by said obtaining step.

14. A method according to claim 12, wherein said generation step generates plural toner cartridge volume discount menus respectively different for the users and derived with a discount rate according to the cumulative number of purchase for each toner cartridge model, based on the demand estimate for the toner cartridge calculated by said estimation step.

15. A method according to claim 12, wherein said generation step generates plural toner cartridge volume discount menus respectively different for the users and derived with a discount rate according to the total cumulative number of purchase of the toner cartridge, based on the demand estimate for the toner cartridge calculated by said estimation step.

16. A method according to claim 12, wherein said generation step generates plural toner cartridge volume discount menus respectively different for the users and derived with a discount rate according to the number of purchase for each toner cartridge model, based on the demand estimate for the toner cartridge calculated by said estimation step.

17. A method according to claim 12, wherein said generation step generates plural toner cartridge volume discount menus respectively different for the users and derived with a discount rate according to the total number of purchase for the toner cartridge, based on the demand estimate for the toner cartridge calculated by said estimation step.

18. A method according to claim 12, wherein said generation step generates plural toner cartridge volume discount menus respectively different for the users and derived with a discount rate according to the number of recovered toner cartridge, based on the demand estimate for the toner cartridge calculated by said estimation step.

19. A method according to claim 12, wherein said generation step generates a toner cartridge volume discount menu to be recommended to each user, based on the demand estimate for the toner cartridge calculated by said estimation step.

20. A method according to claim 12, wherein said estimation step executes a predetermined corrective calculation in the demand estimation for the toner cartridge, based on the result of analysis of said toner cartridge information in the customer information managed by said management step.

21. A method according to claim 12, wherein said informing step informs said data processing apparatus, at designated date and time, of the plural toner cartridge volume discount menus generated by said generation step.

22. A toner cartridge management method for use in a data processing apparatus capable of informing a server apparatus, through internet, of toner cartridge information obtained by communication with a printing apparatus capable of recognizing a mount state and a replacement state of a toner cartridge mounted thereon, the method comprising:
a memory step of collecting and storing the toner cartridge information based on toner cartridge control information informed from said print apparatus;
a transfer step of transferring said toner cartridge information stored in said memory means to said server apparatus;
an obtaining step of obtaining a toner cartridge volume discount menu informed from said server apparatus;
a display control step of causing a display unit to display for browsing the toner cartridge volume discount menu obtained by said obtaining step;
a designation step of designating the toner cartridge volume discount menu displayed for browsing by said display control step; and
an issuing step of issuing a request for purchase of the toner cartridge volume discount to said server apparatus, according to the designation by said designation step.

23. A computer readable memory medium storing a program for causing a server apparatus capable of managing, through internet, customer information utilizing a data processing apparatus for managing toner cartridge information obtained by communication with a printing apparatus capable of recognizing a mount state and a replacement state of a toner cartridge mounted thereon, the program comprising:
a management step of managing the customer information by obtaining said toner cartridge information managed by said data processing apparatus;
an estimation step of calculating a demand estimate for the toner cartridge by analyzing said toner cartridge information in the customer information managed by said management step;
a generation step of generating plural toner cartridge volume discount menus respectively different for the customers, based on the demand estimate for the toner cartridge calculated by said estimation step; and
an informing step of informing said data processing apparatus of the plural toner cartridge volume discount menus generated by said generation step.

24. A computer readable memory medium storing a program for causing a data processing apparatus capable of informing a server apparatus, through internet, of toner cartridge information obtained by communication with a printing apparatus capable of recognizing a mount state and a replacement state of a toner cartridge mounted thereon, the program comprising:
a memory step of collecting and storing the toner cartridge information based on toner cartridge control information informed from said print apparatus;
a transfer step of transferring said toner cartridge information stored in said memory means to said server apparatus;
an obtaining step of obtaining a toner cartridge volume discount menu informed from said server apparatus;
a display control step of causing a display unit to display for browsing the toner cartridge volume discount menu obtained by said obtaining step;
a designation step of designating the toner cartridge volume discount menu displayed for browsing by said display control step; and
an issuing step of issuing a request for purchase of the toner cartridge volume discount to said server apparatus, according to the designation by said designation step.

25. A program stored in the memory medium according to claim 23.

26. A program stored in the memory medium according to claim 24.

27. A server for providing a user with a discount service based on a result of purchase of a consumable, comprising:
identification means for identifying said user and a data processing apparatus based on specifying information for specifying the user and the data processing apparatus, transmitted through a predetermined communication channel;
management means for storing and managing a result of purchase for each user in memory means;
discount information memory means for storing discount information corresponding to the result of purchase for each kind of consumable; and
transmission means for transmitting discount information, calculated by calculation means for calculating the discount information for a user identified by identification means, by referring, in said discount information memory means, to the result of purchase of said user read from said management means, to the data processing apparatus identified by said identification means through said predetermined communication channel.

28. A server according to claim 27, wherein said result of purchase is a result of new purchase for each kind of consumable and/or a result of purchase in the past, said calculation means is capable of calculating plural discount information according to a combination of the result of new purchase for each kind of consumable and the result of purchase in the past, and said transmission means transmits any of said plural discount information calculable by said calculation means, to the data processing apparatus identified by said identification means through said predetermined communication channel.

29. A server according to claim 28, wherein said server apparatus is capable of managing, through a predetermined communication channel, customer information including at least consumable information generated in an output apparatus capable of recognizing a mount state and a replacement state of the consumable, said calculation means calculates a demand estimate for the consumable by analyzing information based on said customer information transmitted from said output apparatus or data processing apparatus through said predetermined communication channel, said information is stored and managed by said management means, and said transmission means transmits demand estimate information, calculated by said calculation means, to said data processing apparatus.

30. A server according to claim 29, wherein said transmission means transmits, to said data processing apparatus, image information provided with an operation button information capable of requesting the demand estimate for the image information for ordering a merchandise.

31. A consumable management method by a server for providing a user with a discount service based on a result of purchase of a consumable, the method comprising:
an identification step of identifying said user and a data processing apparatus based on specifying information for specifying the user and the data processing apparatus, transmitted through a predetermined communication channel;
a readout step of reading, from a memory, a result of purchase including at least the kind and the amount of the consumable for the user identified by said identification step; and
a calculation step of calculating discount information according said read kind and amount of the consumable.

32. A method according to claim 31, further comprising:
a transmission step of any of said plural discount information calculable by said calculation step to the data processing apparatus identified by said identification step;
wherein said result of purchase is a result of new purchase for each kind of said consumable and/or a result of purchase in the past, said calculation step is capable of calculating plural discount information according to a combination of the result of new purchase for each kind of said consumable and the result of purchase in the past.

33. A server according to claim 32, wherein said server apparatus is capable of managing, through a predetermined communication channel, customer information including at least consumable information generated in an output apparatus capable of recognizing a mount state and a replacement state of the consumable, said calculation step calculates a demand estimate for the consumable by analyzing information based on said customer information transmitted from said output apparatus or data processing apparatus through said predetermined communication channel, said information is stored and managed by said management step, and said transmission step transmits demand estimate information, calculated by said calculation step, to said data processing apparatus.

34. A consumable management method according to claim 33, wherein said transmission step transmits, to said data processing apparatus, image information provided with an operation button information capable of requesting the demand estimate for the image information for ordering a merchandise.

35. A memory medium storing program codes for realizing the consumable management method according to claim 31.

36. A program for realizing the consumable management method according to claim 31.
